(19) United States
(12) Patent Application Publication
(10) Pub. No.: US 2013/0132959 A1
(43) Pub. Date: May 23, 2013

(54) SYSTEM FOR GENERATING OR USING QUESTS

(71) Applicant: Robert J. Moore, San Jose, CA (US)

(72) Inventor: Robert J. Moore, San Jose, CA (US)

(73) Assignee: Yahoo! Inc., Sunnyvale, CA (US)

(21) Appl. No.: 13/304,024

(22) Filed: Nov. 23, 2011

(51) Int. Cl. G06F 9/46

(52) U.S. Cl. 718/100

(57) ABSTRACT

Example methods, apparatuses, or articles of manufacture are disclosed that may be implemented, in whole or in part, using one or more computing devices to facilitate or otherwise support one or more processes or operations associated with a system for creating or using one or more quests.

### BACKGROUND

1. Field

The present disclosure relates generally to information processing and, more particularly, to a system for creating or using one or more quests that may be utilized, at least in part, in or with a client device.

2. Information

Content is everywhere. For example, in a virtual or digital world provided by the Internet, such as the World Wide Web or simply the Web, a wide variety of content, such as web pages, text documents, graphics, images, audio or video files, or the like is continually being created, published, accumulated, communicated, stored, or the like. Communication paradigms supported by the Internet, such as, for example, on-line social networks, virtual portals, or the like have become commonplace, with new content seemingly being added daily. These networks or portals may, for example, feature user-generated content (e.g., photo sharing databases, knowledge resources, opinion blogs, etc.), service provider-generated content (e.g., news or sports web pages, movie or entertainment blogs, travel or shopping sites, etc.), or the like in an attempt to offer richer or more satisfying content experiences for users.

Likewise, in a physical or real world, proliferation of news, service, enterprise, government, healthcare, science, art-related content, or the like may facilitate human interaction with different strands of content on a regular or even daily basis, thus, making content a value-adding material of business. With such an overabundance of content being accessible or available in a virtual as well as physical world, commercial enterprises, content providers, event organizers, or the like may desire to increase user engagement or strengthen user loyalty. For example, offering richer or more satisfying user experience, on-line or otherwise, may provide incentives for people to spend more time with particular content of interest (e.g., more dwell or shopping time, etc.), may entice users to explore additional content (e.g., more page or product views, etc.), or the like. This may create opportunities for advertising, for example, may increase on-line or foot traffic to a particular retailer or service provider and, thus, may positively affect revenue.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a schematic diagram illustrating certain functional features of an implementation of an example computing environment.

FIG. 2 is a flow diagram illustrating an implementation of an example process for a quest.

FIGS. 3A through 3J are example representations of screenshot views of a display associated with a client device according to an implementation.

FIGS. 4A through 4Q are example representations of screenshot views of another display associated with a client device according to an implementation.

FIGS. 5A through 5G are example representations of screenshot views of still another display associated with a client device according to an implementation.

FIGS. 6A and 6B are example representations of screenshot views of yet another display associated with a client device according to an implementation.

FIG. 7 is a schematic diagram illustrating an implementation of a computing environment associated with one or more special purpose computing apparatuses.

FIGS. 8A and 8B are example representations of screenshot views of still another display associated with a client device according to an implementation.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Some example methods, apparatuses, or articles of manufacture are disclosed herein that may be used, in whole or in part, to facilitate or support one or more processes or operations associated with a system for generating or using one or more quests. As used herein, “quest” may refer to a set of one or more tasks or objectives usually involving an exploration of a virtual (e.g., on-line, etc.) or physical (e.g., real world, etc.) space, an execution or completion of which may allow or otherwise qualify a user to receive one or more rewards. It should be appreciated that in the context of the present disclosure, “user,” “member,” “player,” “quester,” or the plural form of such terms may be used interchangeably. In some instances, a quest may be represented via or structured, for example, in connection with a game-type framework or process that be may be centered around executing or completing a number of specified exploration or travel-related tasks or objectives, in a virtual or real world, just to illustrate one possible implementation. As used herein, “game-type”may refer to an activity engaged in for diversion or amusement via a suitable special purpose computing device. In some implementations, a quest may be realized as a trivia-type quest, for example, comprising one or more interactive responses to one or more posed questions presented to a user in connection with a quest-related task or objective, such as at a particular web page, site, blog, or the like. As will be seen, a quest may comprise, for example, a number of components or elements, such as a quest story, location, task or objective, or reward, though claimed subject matter is not so limited. For example, in certain implementations, one or more elements of a quest may be omitted or combined in some manner.

As will be described in greater detail below, a quest may comprise, for example, or be performed in connection with one or more machine-confirmable actions of a user. As used herein, “machine-confirmable action” may refer to one or more actions a user may perform via a client device that an associated server may confirm via a suitable communication, such as by the client device, third-party application programming interface (API), or the like. As will also be seen, a machine-confirmable user action may include loading a uniform resource locator (URL), submitting a geo-location, submitting an answer, performing a gesture (e.g., detectable via an accelerometer, etc.), submitting a review (e.g. to a web page, site, blog, etc.), earning a certain score, etc., just to name a few examples. In this context, “client device” should be interpreted broadly and may refer to any kind of special purpose computing platform or apparatus that may be capable of communicating with other computing platforms or devices through wired or wireless transmission or receipt of signals or like content over suitable communications networks according to one or more communication protocols.

As described below, a special purpose client device may comprise, for example, a mobile communication device, a stationary computing device, etc. or any combination thereof. A mobile device may comprise, for example, a client device that may from time to time have a position or location that changes. A stationary computing device may comprise, for example, a client device that may have a position or location that typically, although not necessarily, does not change. As a way of illustration, special purpose client devices, which may herein be called simply client devices, may include, for example, cellular telephones, satellite telephones, smart telephones, voice over internet protocol (VoIP) or IP telephones, desktop computers, personal digital assistants (PDAs), laptop computers, personal entertainment systems, tablet personal computers (PC), personal audio or video devices, personal navigation devices, e-book readers, or the like. It should be appreciated, however, that these are merely illustrative examples of client devices that may be utilized in connection with one or more quests, and that claimed subject matter is not limited in this regard.

Before describing some example methods, apparatuses, or articles of manufacture in greater detail, the sections below will first introduce certain aspects of a quest game-type framework in which a quest may be implemented. It should be appreciated, however, that a quest game-type framework is provided herein as merely example, and claimed subject matter is not limited in this regard. As was indicated, at times, a quest may comprise, for example, a quest story, location, task or objective, or reward. For example, a quest story may be conceptualized as an experiential wrapper or narrative linking parts of a quest that may as a result add an elaborate, interesting, dramatic, etc. layer to one or more quest tasks or objectives. As will be described in greater detail below, a quest story may comprise, for example, a personal, historical, fictional, etc. instruction that may be generated by quest authors or editors, such as one or more designers, advertisers, providers of goods or services, users or members of a social network or virtual community, or the like. In some instances, an instruction may comprise, for example, a task-like instruction asking a user to compete one or more certain tasks or objectives, as will also be seen. At times, an instruction may comprise an adventure-related or story-related instruction, for example. As used herein, “adventure” may refer to a task or objective-related experience that a quest author may wish a user to explore, participate in, or otherwise undertake in connection with a particular quest. In some instances, an adventure-related instruction may comprise, for example, a story-related instruction having one or more fictional narrative elements, a non-fictional narrative elements, a navigational or quest-related clue, etc., or any combination thereof. By way of example but not limitation, a quest story may comprise, for example, a request to locate or retrieve an item (e.g., a lost ring, etc.), deliver an item (e.g., a letter, message, etc.), or the like. In some instances, a quest story may link or tie together a number of individual quests so as to create a series of quests. At times, quest series may be structured to include a certain hierarchy or sequence, for example, where certain one or more higher-level quests may be “unlocked” progressively depending, at least in part, on executing or completing one or more lower-level quests in the series. For example, a user may be asked to execute or complete a first quest in a quest series in order to “unlock” or progress to the next quest and so forth, just to illustrate one possible implementation.

As was alluded to previously, on-line users may, for example, experience or view web pages as virtual “places,” which users may explore or to which they may “navigate.” As described below, a quest-related location may comprise, for example, a virtual or on-line location, a physical or real world location, or any combination thereof. A quest-related location may depend, at least in part, on a type of a quest that a user engages in, for example, or a type of a client device that a user employs in connection with the quest. For example, if a user employs a mobile device, a quest may take the user to a virtual or on-line location as well as a physical or real world location via a so-called mixed reality quest. As used herein, a “mixed reality” quest may refer to a type of a quest that combines one or more virtual elements (e.g., a story, character, etc.) with one or more physical elements (e.g., a real-world or physical location, etc.) of a quest. For example, as will be seen, in a mixed reality quest, a user may visit a physical or real-world location on the auspices of a virtual task, such as to explore or look for a virtual element in a physical place even though the virtual element is not really (e.g., physically, etc.) there. A physical or real world location may comprise, for example, a certain physical place, such as a store, park, particular place, etc. that may be specified via a suitable network location-based service (LBS) in connection with a geo-location feature of a client device (e.g., via trilateration, triangulation, etc.). It should be noted that in some instances in addition to or instead of a story, character, etc., a virtual element may comprise, for example, a task or objective-related element, such as a trivia question, request, or like instruction. An example of a mixed reality quest will be described in greater detail below. A user of a stationary device, such as a desktop, for example, may participate in a web version of a quest or a “web-type” quest by “visiting” or navigating to a virtual or on-line location, as will also be seen. In certain implementations, a virtual or on-line location may comprise, for example, a web site, web page, blog, etc. specified via an associated uniform resource locator (URL), as was indicated. It should be appreciated that these are merely examples relating to quest locations or quest types, and claimed subject matter is not so limited.

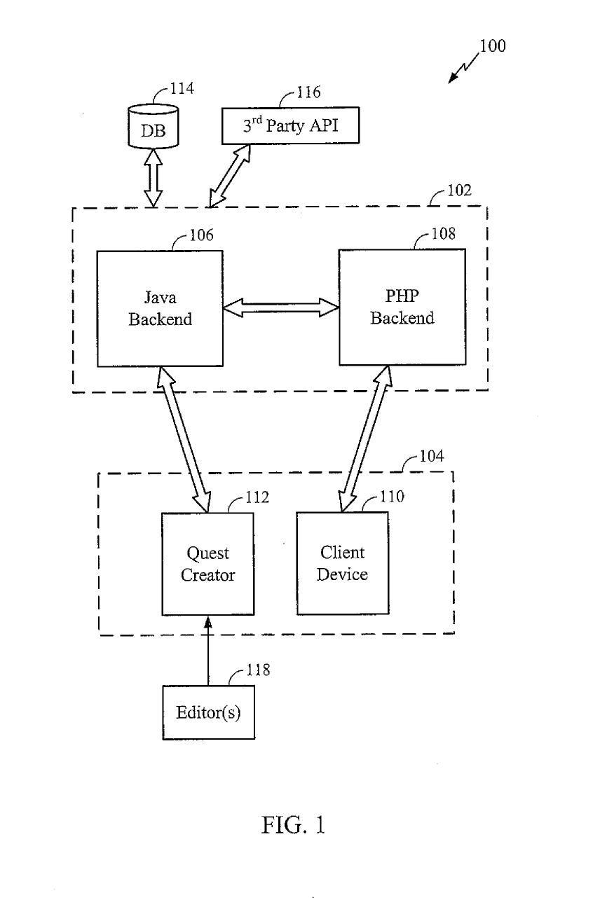

Continuing with the above discussion, in an implementation, a quest-related task or objective may comprise, for example, a particular machine-confirmable action that a user may perform in order to earn or obtain a reward, to fulfill a quest or series of quests, or the like. Thus, as will be seen, in some instances, a task or objective may comprise, for example, a user action correlating or corresponding to an electronically-detectable action confirmable via an application of a system or server-side process. For a web quest or mixed reality quest, a narrative or instruction-related part or component of a task or objective may, for example, be somewhat similar or, at times, the same, while a system or server-confirmable part or component may differ. For example, a narrative part of a quest task or objective may instruct a user to “go to the end of the Huntington Beach pier and talk to surfing champ, Carissa Moore,” as illustrated below. For a web version of a quest, a correlating or corresponding machine-confirmable user action may comprise, for example, navigating to a particular URL (e.g., uploading a URL, etc.) on a certain web site (e.g., www.GrindTV.com, etc.) that has an article or blog about Carissa Moore winning the U.S. Open of Surfing. With respect to a mixed reality quest, a machine-confirmable user action may, for example, be to “check in” near the end of the Huntington Beach pier. As was indicated, a mixed reality quest may, for example, combine or otherwise associate one or more virtual elements of a quest with one or more physical or real world elements. Thus, for this example, a user may be “looking” for Carissa Moore at the end of the Huntington Beach Pier even though she is not physically there. It should be appreciated that claimed subject matter is not limited to these particular actions, tasks or objectives, or components or elements, of course. Certain features of an example client-server-type computing environment that may be utilized, at least in part, in connection with a quest will be described in greater detail below with reference to FIG. 1.

As used herein, “check in” or the plural form of such term may refer to an electronically detectable event or action of registering, reporting, or sharing a user's location, on-line or otherwise, via one or more appropriate signaling techniques. For example, in some instances, a “check in” may comprise electronically uploading a geo-location of a user from an associated mobile device via a suitable LBS, just to illustrate one possible implementation. Any suitable technology, such as push technology, pull technology, or the like, or any combination thereof may be employed herein. These technologies are known and need not be described here in greater detail. As will be seen, a “check in” may, for example, be used, at least in part, by a suitable process to confirm that a user performed a quest-related task or objective, such as traveled or navigated to a particular location, or the like. Of course, these are merely examples relating to a quest task or objective, and claimed subject matter is not limited in this regard.

As previously mentioned, by executing or completing a quest or a particular task or objective within a series of quests, for example, a user may obtain a reward. A reward may comprise, for example, a physical reward, virtual reward, or any combination thereof. For example, a user may receive or obtain a number of virtual rewards, such as displayable experience points, titles, badges, avatars, avatar animations, avatar accessories, custom virtual buttons, images, copyrighted or otherwise, or any other suitable digital media rewards. In addition, rewards may take the form of redeemable coupons, ringtones, songs, for example, that may be distributed electronically (e.g., downloadable, etc.). In some instances, a coupon may, for example, be exchangeable for a physical good or service, such as a physical item or monetary discount. At times, a virtual item or coupon may, for example, be delivered or otherwise communicated to a user immediately upon or after executing or completing a quest, such as in real time or near real time. In this context, “real time” may refer to an amount of timeliness of signals, which may have been delayed by an amount of time attributable to electronic communication as well as other signal processing. In addition, a reward for a quest may be displayable or otherwise capable of being visible to users before they “accept” a particular “challenge” (e.g., a quest, etc.) to allow users to determine if a certain reward seems worth an effort. Optionally or alternatively, a display may provide an indication or availability of a reward (e.g., via a text, blurred or pixelized image, etc.), for example, but an image of a reward may be hidden or otherwise image-edited until or after a user executes or completes a quest. This may be particularly useful, for example, with respect to coupons or like rewards featuring promotional, discount, key, or like reward codes, task-related URLs (e.g., downloadable, music-related, etc.), etc. that may be hidden or blurred and may reduce risks or instances of gaming the system. It should also be noted that in certain implementations a reward may not be visible in a quest application window before users' accepting a quest challenge.

In an implementation, a virtual reward may comprise a virtual or digital button, for example, which may include customized artwork and may be displayed on a user's profile page. Displayable badges or titles, as well as avatar clothes, accessories, or animations may also provide higher quality, engaging rewards for users. In some instances, avatar customization may be an engaging or desirable reward in a quest. For example, rather than making avatar-related content instantly available to users (e.g., with execution or completion of a task or objective, etc.), it may be offered progressively by having users to earn or “unlock” certain content via executing or completing a lower-level quest. This may bring new value to avatars by allowing users to “show off” their progressive quest achievements through avatars reflecting a sense of style or personalities. Avatar accessories may, for example, be conceptualized or implemented more broadly than clothing accessories. For example, as a reward, avatar accessories may allow or enable users to do something additional with their avatars, such as control their motions in some manner. An avatar accessory may, for example, comprise a soccer ball that may include an animation allowing or enabling an avatar to kick or bounce it. As alluded to previously, a reward may comprise, for example, a physical reward, such as a monetary discount, cash-back amount, physical coupon mailed or otherwise provided to a user, a physical item, or the like. Thus, by way of example but not limitation, a reward may include, for example, a redeemable electronic or physical coupon, one or more displayable experience points, one or more redeemable experience points, a displayable title, a displayable virtual badge, a graphical avatar image, a graphical avatar accessory, an animated avatar accessory, an animated avatar image, an electronic coupon exchangeable for a physical good or service, an electronic coupon representative of a monetary discount for a good or service, a displayable virtual button, a redeemable electronic gift card, a redeemable electronic gift certificate, a monetary discount, a good or service, a physical item, etc., or any combination thereof. Of course, details relating to quest rewards are merely examples to which claimed subject matter is not limited.

As will be described in greater detail below, a quest game-type framework may be advantageously utilized, in whole or in part, to associate one or more users with content. As used herein, “content” may refer to any expression, realization, or communication of generated, owned, or adapted information, knowledge, digital signals, experience, or thing. In some instances, content may comprise, for example, local content that may be relevant to a particular user's situation, descriptive of a particular locale, or the like. Content may include, for example, digital content associated with one or more web pages or on-line properties of a particular service provider, such as Yahoo!® (e.g., www.yahoo.com), physical content (e.g., food, merchandise, etc.) associated with one or more physical locations (e.g., local stores, restaurants, etc.), etc., or any combination thereof. In some instances, content may include, for example, non-game-related content, such as on-line content generated without a diversion or amusement-oriented task or objective (e.g., on-line articles, blogs, photos, videos, etc.). Particular examples of content, non-game-related or otherwise, will be illustrated in greater detail below.

An “on-line property” or “property,” as the terms used herein, may refer to a collection of on-line content or resources that may have an affiliation-type relationship with a particular service provider and organized or otherwise grouped together, such as by category, topic, theme, format, activity, or like concepts. In some instances, an on-line property may include, for example, a domain-related collection of content or resources, though claimed subject matter is not so limited. As a way of illustration, a service provider, such as, for example, Yahoo!® (e.g., www.yahoo.com) may feature one or more on-line properties (e.g., on a portal page, etc.) that may typically, although not necessarily, comprise separate domains or sub-domains, such as Yahoo!® Search (e.g., http://search.yahoo.com), Yahoo!® Mail (e.g., http://mail.yahoo.com), Yahoo!® News (e.g., http://news.yahoo.com), Yahoo!® Sports (e.g., http://sports.yahoo.com), Yahoo!® Finance (e.g., http://finance.yahoo.com), Yahoo!® Answers (e.g., http://answers.yahoo.com), etc., just to name a few examples. On-line properties may be enabled or otherwise supported by one or more special purpose computing platforms or servers (e.g., back-end, etc.), dedicated or otherwise. Generally, on-line properties may, for example, be presented (e.g., to a user, etc.) via a dynamic compilation of relevant electronic documents, images, hyperlinks, selectable tabs, icons, or like content listed in a main portal or home page, just to illustrate one possible implementation. At times, on-line properties may form, for example, a network of related or interrelated web sites, web pages, portal pages, home pages, or like electronic documents, centrally-managed or otherwise. Of course, these are merely examples relating to on-line properties, and claimed subject matter is not limited in this regard.

As used herein, “document,” “web document,” or “electronic document” should be interpreted broadly and may include, for example, one or more communicated or stored digital signals (e.g., physical states) representing any content, such as a source code, text, image, audio, video file, or the like that may be read by a special purpose computing apparatus and may be played or displayed to a user. At times, documents may include, for example, one or more embedded references or hyperlinks to images, audio or video files, or other documents. For example, one type of reference that may be embedded in a document and used to identify or locate other documents comprises a Uniform Resource Locator (URL). As a way of illustration, documents may comprise an Extensible Markup Language (XML) document, a web page, a media file, a page pointed to by a URL, a blog post, an e-mail, a text message, just to name a few examples.

As previously mentioned, in an implementation, a quest may include, for example, a story and a set of clues that may associate one or more users with content by enabling or allowing users to navigate to or visit a specified quest-related location (e.g., on-line, physical, etc.). By navigating to or visiting a location or performing a machine-confirmable user action (e.g., a “check in,” entering text, clicking a button, uploading a photo, etc.), for example, a user may execute or complete a quest-related task or objective. If certain one or more tasks or objectives for a quest are executed, a user may, for example, earn or obtain a reward (e.g., graphic or virtual button, avatar image or accessories, coupon, etc.). As will be seen, in some instances, a process for a quest may be relatively independent of or agnostic to a source of content, such as a particular on-line property or physical location. For example, a quest may utilize, at least in part, one or more existing non-game-related web pages (e.g., articles, blogs, images, videos, etc.) as quest locations, though claimed subject matter is not so limited. This may, for example, provide benefits in terms of increased agility in designing, creating, or implementing a quest or series of quests. At times, one or more enhanced features, such as item graphics or ads, for example, involving at least partial integration with one or more existing on-line properties may also be utilized.

As will be described in greater detail below, a process for a quest may be implemented, in whole or in part, via a client-server network in which one or more servers may operate as a hub, for example, serving one or more client devices, such as a mobile device, stationary device, or the like. In an implementation, a client device may include, for example, any suitable web browser or other application to communicate with a server via a suitable electronic network, such as the Internet. A client-server network may, for example, enable a user or other party to create one or more versions of a quest, such as a web quest, mixed reality quest, or any combination thereof. It should be noted that in certain example implementations, one or more quest-related servers or client devices may, for example, comprise peer devices facilitating or supporting one or more processes or operations for creating or using a quest via a peer-to-peer communication, as will also be seen. In such a case, a client-server network may comprise, for example, a suitable number of peer devices serving at times as both server and client devices so as to perform similar actions or functions as in a client-server network (e.g., create a quest, confirm user actions, etc.). Particular features of a client-server network will be described in greater detail below.

In an implementation, a quest may be designed, created, or implemented for a group, such as for a team of users. To illustrate, a user may invite, via an electronic communication or otherwise, one or more suitable users, such as users who are currently logged in, for example, to join a temporary team or group of mutually interacting users to share a quest. For this example, a team or group of users may, for example, divide certain quest-related tasks or objectives among themselves so as to share credit for executing or completing a task or objective or receive a reward. Thus, if one user executes or completes a certain task or objective (e.g., finds an item, etc.), for example, all users in a team may share a credit or receive a reward. In some instances, such as in a mixed reality quests, while in a team, users may be able to see whereabouts of their teammates, such as on a digital map in a display associated with a mobile device, for example, or may mutually communicate via a team chat channel. In certain implementations, a user may, for example, quit or “drop out” of a team at any time, if desired, or a creator of the team may disband it. If a team drops to a certain number of users, such as one user, for example, it may also be disbanded (e.g., automatically, by a team creator, etc.). In one particular implementation, a team or group of up to five users may participate in a quest, though claimed subject matter is not so limited.

Attention is now drawn to FIG. 1, which is a schematic diagram illustrating certain features of an implementation of an example client-server-type computing environment 100 that may facilitate or support, in whole or in part, one or more processes or operations associated with a quest. As previously mentioned, example computing environment 100 may be operatively enabled via one or more special purpose computing platforms or apparatuses, information communication devices, information storage devices, computer-readable media, applications or instructions, various electrical or electronic circuitry and components, input or output signals, etc., as described herein with reference to particular example implementations.

As illustrated, computing environment 100 may include a suitable server, referenced generally in a dashed line at 102, for example, that may be associated with an on-line property, service provider, etc. and may be operatively coupled to a suitable communications network that a user may employ to communicate with server 102 by utilizing resources 104. It should be appreciated that computing environment 100 may be implemented in the context of one or more public networks (e.g., the Internet, the World Wide Web) private networks (e.g., intranets), Real Simple Syndication (RSS) or Atom Syndication (Atom)-based applications, etc., just to name a few examples.

Server 102 may comprise, for example, one or more special purpose computing platforms, such as a java back-end 106 and a PHP back-end 108. While illustrated in this example as being separate, it should be appreciated that all or part of java back-end 106 may be provided within or otherwise co-located or coupled with PHP back-end 108, for example, or vice versa. Server 102 may, for example, utilize any suitable identification credentials (ID) associated with an electronic profile that a user may establish or create in connection with a suitable service provider (e.g., Yahoo!® ID, etc.) to participate in a quest. For example, as described below, based, at least in part, on a user ID, server 102 may provide or serve a quest to a client device 110, keep track of quest progress, verify or issue rewards, keep track of questing history, or the like. As previously mentioned, client device 110 may comprise, for example, any suitable special purpose computing platform associated with or implemented in connection with a mobile device, stationary device, client application, web application, browser, or the like. It should be appreciated that even though one client device 110 is illustrated in FIG. 1, any suitable number of client devices may be associated with operating environment 100. As illustrated generally via a number of double-sided arrows, java back-end 106 may provide an application programming interface (API), which may be used, at least in part, to create one or more types of quests via a suitable authoring tool, such as a quest creator 112, for example, retrieve suitable quest details via PHP back-end 108, communicate or interact with a database 114 or a third-party API 116 regarding quest-related details, or the like.

In the configuration shown, PHP back-end 108 may comprise, for example, a server-side processing layer for client device 110, though claimed subject matter is not so limited. PHP back-end 108 may, for example, serve or provide a quest to client device 110, retrieve or otherwise obtain quest-related details from java back-end 106, process one or more machine-confirmable user actions (e.g., a “check in,” etc.) captured via client device 110, or the like. As previously mentioned, machine-confirmable user actions may comprise, for example, uploading a URL associated with a web page representative of an on-line quest-related location, registering or reporting a physical location (e.g., global positioning system (GPS) coordinates, etc.), such as via a location-tracking feature of a mobile device, interacting with a web page element (e.g., entering text, clicking a button, uploading a photo, etc.), interacting with a mobile device (e.g., making a gesture or like motion, etc.), or the like.

Database 114 may comprise, for example, any suitable information repository capable of storing or otherwise retaining in some manner any organized collection of information in the form of binary digital signals. Database 114 may be accessible over the Internet, for example, or may be associated with an intranet accessible by java back-end 106. As previously mentioned, database 114 may store one or more quests as well as quest-related details, such as, for example, quest histories, rewards, or the like with reference to a user ID or a user profile associated with a particular service provider.

As also illustrated, computing environment 100 may, for example, include any suitable third-party API, referenced generally at 116, that may be used, in whole or in part, to electronically confirm one or more actions of a user (e.g., machine-confirmable user actions, etc.). For example, third-party API 116 may communicate with java back-end 106 or server 102 so as to confirm a physical geo-location (e.g., the Foursquare™ API, etc.), or that a user posted a restaurant review (e.g., the Yelp® API, etc.) or status update (e.g., the Facebook® API, etc.), just to name a few examples. It should be noted that in some instances a user may be asked to authorize server 102 to access suitable user-related information on a user profile, for example, associated with third-party API 116. Claimed subject matter is not so limited, of course.

As previously mentioned, resources 104 may comprise, for example, any kind of special purpose client device 110, such as a mobile device, personal digital assistant, e-book reader, desktop computer, or the like capable of communicating or otherwise having access to the Internet over a wired or wireless communications network. Client device 110 may comprise, for example, any suitable application window as a graphical user interface for a computing application or platform to manage or otherwise manipulate visual content on an associated display. As used herein, a “graphical user interface” (GUI) may refer to a program interface that utilizes displayed graphical information, such as in the form of stored digital signals, for example, to allow a user to control or operate a special purpose computing platform associated with a client device by a pointer or a pointing device. As will be seen, a user may, for example, employ a pointer or pointing device to select one or more quests, populate fields, input commands, or the like via a display, touch screen, etc. associated with a client device. A client device, a display or touch screen typically comprise specific hardware, whereas a GUI typically comprises an application capable of being executed by hardware. GUIs are known and need not be described here in greater detail. In some implementations, a client device may also comprise a network browser or a similar application that enables the device to interact with display content that may be served via a network, such as the Internet. Of course, various implementations of GUI are possible, and it is not intended to limit claimed subject matter to a particular implementation.

Resources 104 may include an authoring tool, such as, for example, quest creator 112 that may provide a graphical user interface (GUI) for one or more quest authors or editors 118 so as to create or generate one or more suitable quests. As will be seen, resources 104 may also include a quest application window that may be rendered by a browser comprising, for example, any suitable application that may reside on or otherwise be associated with client device 110. Client device 110 may, for example, interact with PHP back-end 108 and may display quest-related details, content, etc. in response to one or more signals received from PHP back-end 108. As described below, in some instances, such as in a peer-to-peer configuration, client device 110 may, for example, operate to manage or oversee, at least in part, one or more processes in connection with confirming user actions, communicate with other peer devices to provide feedback regarding progress on a quest based, at least in part, on user actions, or the like. Again, even though a certain number of resources 104 are illustrated in FIG. 1, it should be appreciated that any number of resources may be operatively coupled to server 102.

As will also be seen, a quest application window may comprise, for example, a GUI associated with a display of a client device to facilitate or support quest-related client-server interaction. For example, a user may use a quest application window to view a quest log in which one or more active quests may be listed or displayed. A quest application window may also provide a feedback to a user regarding a progress on a quest, for example, may notify a user if a particular task or objective, quest, series of quests, etc. is executed or completed, mark current, pending, executed or completed tasks or objectives, or the like. In some instances, such as if a user is employing a stationary client device (e.g., a desktop computer, etc.), for example, a quest may be accessed via a quest application window realized as a quest sidebar that may appear in a suitable web browser (e.g., Internet Explorer®, Mozilla Firefox®, etc.). At times, such as if a mobile device (e.g., a smart phone, PDA, etc.) is employed, for example, a quest may be accessed via a quest application window comprising a mobile application residing on the device.

In an implementation, if a particular quest is selected, such as from a quest log, for example, one or more quest-related details, such as a quest story, task or objective, reward, etc. may be displayed in a quest application window. If a “check in” occurs, such as via an upload of a particular quest-related URL or geo-coordinates, for example, as discussed above, appropriate or suitable parts of a story may be displayed in a quest application window. By utilizing this approach, in whole or in part, an experience of “going” or navigating to any suitable location (e.g., a web page, on-line property, etc.) as well as interacting (e.g., talking, etc.) with any associated character on a web page may be advantageously simulated. In other words, in some instances, a quest application window as well as quest-related graphics may, for example, appear on a web page by being rendered independently of content provided by a service provider, web site, web page, or the like. For this example, since quest-related graphics or details may not be integrated with content of an on-line property provider and, as such, may not appear on a web page itself, participation by the provider or web site may not be needed or otherwise useful. Claimed subject matter is not so limited, of course.

As will also be seen, a quest application window may include, for example, a number of quest-related graphics, such as one or more character portraits, avatars, avatar accessories, virtual items, badges, awards, or the like. Likewise, here, one or more images may, for example, be linked to any suitable URL or geo-location so as to simulate executing or completing a quest-related task or objective, such as finding a certain object on a web page, or the like. An example may include finding a particular graphic, which may appear arbitrary, such as a “football” or even “lost teddy bears” on ESPN Inc. web pages, for example, accessible via http://espn.go.com, since the graphic may be displayed in a quest application window independently of these web pages, as discussed above, if a particular URL is loaded. In other words, no participation by a web site or web page, such as http://espn.go.com, for example, may be needed or otherwise useful.

At times, service providers, on-line property providers, or the like may wish to participate in a quest. Here, quest-related graphics may, for example, be hidden on respective web pages. For example, Yahoo!® may hide smiley faces or “smileys” (e.g., [symbol] , etc.) in the middle of web pages or behind fake ads. This may create a better user experience by allowing or enabling, for example, within-page hunting. Also, quest-related graphics may be placed or positioned strategically, such as, for example, next or immediately adjacent to certain areas of a web page (e.g., next to display ads, etc.). Of course, these are merely examples relating to placing quest-related texts or graphics, and claimed subject matter is not so limited. Particular examples of a quest application window will be illustrated in greater detail below.

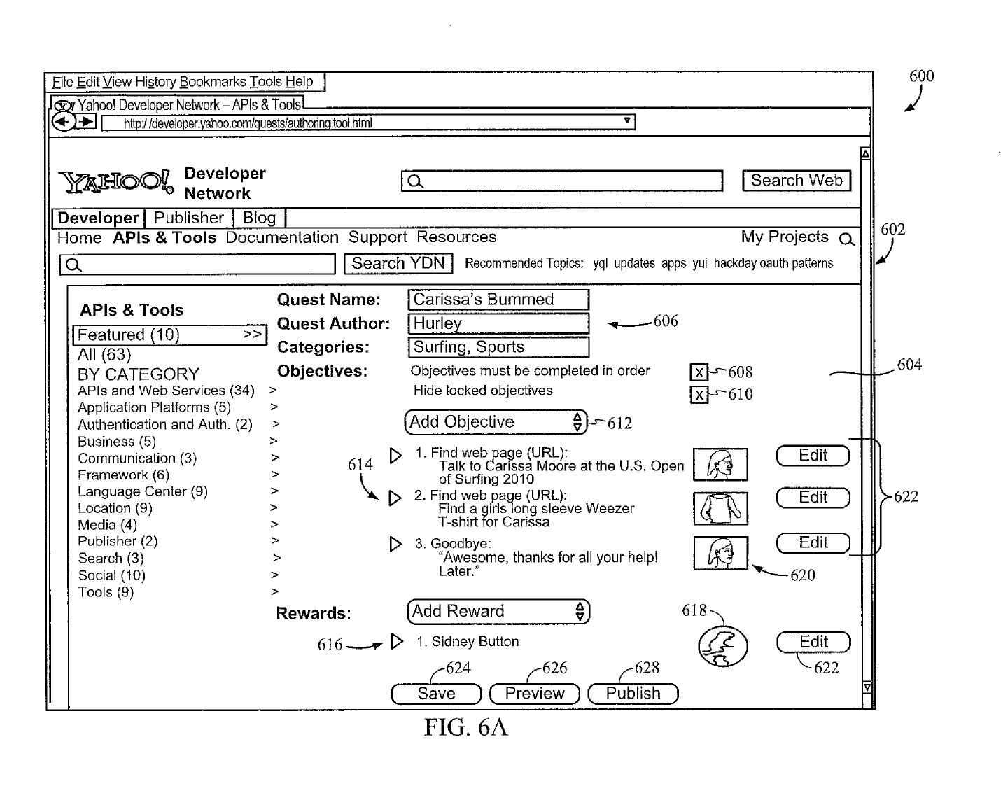

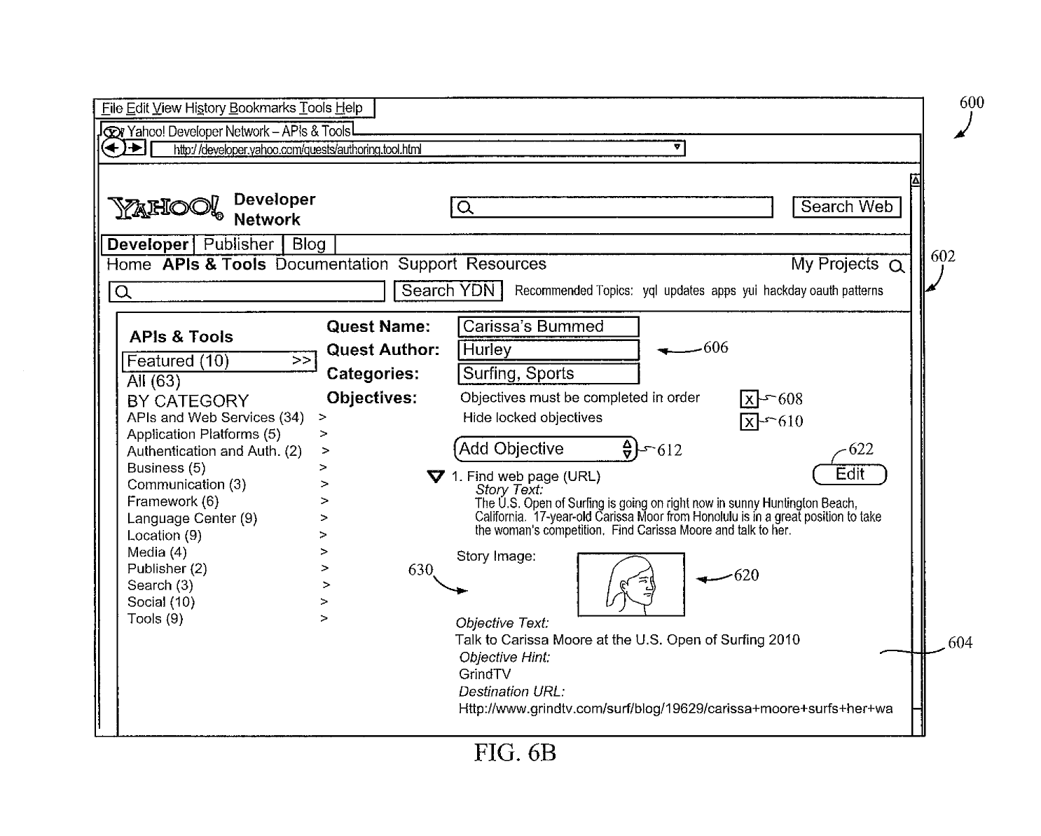

As was indicated, an authoring tool, such as quest creator 112, for example, may allow or enable one or more editors 118 to create or generate a number of suitable quests as well as upload quests into a suitable server, such as server 102. As will be seen, quest creator 112 may comprise a GUI via which one or more editors 118 may enter or input a quest story, quest task or objective, location, reward, or the like via a number of input fields. A quest story may comprise, for example, a text having one or more text strings or associated URLs. Quest creator 112 may allow for suitable flexibility in terms of how one or more parts or components of a quest (e.g., story, location, task or objective, reward, etc.) may be attained, combined, or intertwined. For example, quest author or editor 118 may reveal one or more tasks or objectives progressively or all at once, structure tasks or objectives to be executed or completed in a certain order or in any order, mix different tasks or objectives in a quest, have certain tasks or objectives to be executed or completed contemporaneously (e.g., enter a particular text while on a particular web site or at a particular GPS-enabled location, etc.), or the like. Certain examples of an authoring tool, such as quest creator 112, for example, will be described in greater detail below with reference to FIGS. 6A-6B.

In some instances, quest creator 112 may, for example, be accessed by a user from a quest-related web site or, optionally or alternatively, from client device 110. For example, in an implementation, a user may select or manage a quest via a suitable quest-related web site. Here, a user may log in with an appropriate user ID (e.g., Yahoo!® ID, etc.) and may view a list of available or applicable quests, quests for which a user is eligible, or the like. Via a quest-related web site, for example, a user may read or gather quest-related details and may start or participate in a selected quest. At times, a quest-related web site may, for example, comprise user profiles or personal web pages on which quest-related rewards, experience points, or like achievements may be displayed or viewed.

As alluded to previously, a quest may be created or generated, for example, by one or more quest authors or editors 118. As used herein, “editor” or the plural form of such term may refer to a person or entity that may be capable of participating in one or more processes or operations associated with computing environment 100 (e.g., via an authoring tool, etc.) and may benefit, directly (e.g., commercially, virtual or physical rewards etc.) or indirectly (e.g., fun experience, social interaction, etc.), from participation. As a way of illustration, editor 118 may comprise, for example, a provider of an on-line property (e.g., a Yahoo!® editor, etc.), an advertising sponsor (e.g., a retailer, etc.), a user (e.g., logged in, etc.), or the like, or any combination thereof. A provider of an on-line property, such as a Yahoo!® editor, for example, may employ articles, stories, images, videos, blogs, etc. as parts or components of a quest. For example, a Yahoo!® editor may generate or create a quest and may use it to increase on-line traffic to a particular web page with one or more display ads. More specifically, an article or blog-related quest may be written as a companion to a particular Yahoo!® article or blog, for example, deriving a quest storyline from the article or blog, as will be illustrated below. As such, an article-related quest may, for example, add value, derive additional value, etc. to existing Yahoo!® content. A quest may also facilitate or support discovering additional content, for example, within or across one or more Yahoo!® web sites or on-line properties by drawing a user's attention to particular content of interest or otherwise provoking user curiosity. Of course, a description of a quest or its benefits is merely an example, and claimed subject matter is not so limited.

In one implementation, a quest may, for example, be created or generated by an advertising sponsor to comprise a form of advertising. For example, a so-called sponsored quest may comprise a form of advertising in which a business or individual may pay for a particular quest. A sponsored quest may, for example, take or entice players to a sponsor's web site or physical world business or store, as previously mentioned. A sponsored quest may, for example, offer or provide one or more premium rewards that may not be capable of being designed or created via a regular or standard (e.g., provided, etc.) graphical reward creator. By way of example but not limitation, a premium reward may include, for example, one or more coupons, coupon codes, avatar accessories, avatar animations, 3D graphics, ringtones, downloadable songs, copyrighted content, or the like. As such, a sponsored quest may effectively drive on-line traffic to a particular company's web site or foot traffic to a particular physical store, distribute branded items or rewards, redeemable or exchangeable coupons, or the like, just to name a few examples. In some instances, virtual reward items may provide an opportunity for advertisers, for example, since higher-quality virtual items may be relatively inexpensive for an advertising agency to create compared to a cost of producing a physical item. Yet higher-quality branded virtual items may, at times, provide value to a user. For example, a higher-quality electronic device or appliance, such as a branded model (e.g., an Apple® IPad®, etc.) that includes clever animations enabling an avatar to use them may provide fun or engaging content to users, while utilizing targeted advertisements. In addition, premium rewards may take the form of virtual coupons, for example, exchangeable or redeemable for physical goods or services, as was also indicated. Again, claimed subject matter is not so limited.

In some implementations, a quest may be created or generated, for example, by a user, as previously mentioned. Here, a reward may typically, although not necessarily, lack monetary value. At times, a hunt for or within a quest-related location, on-line or otherwise, for certain hidden content may, for example, comprise a reward. In some instances, an authoring user or author may offer self-generated digital content as a reward. For example, a suitable quest creator, such as quest creator 112 of FIG. 1, may include a graphical reward creator or like application, which may enable a quest author to create one or more custom graphical rewards. In some instances, a graphical reward creator may comprise, for example, an application for creating virtual custom buttons, just to illustrate one possible implementation. With such an application, an author may upload an image, may position or resize it as a layer on a 3D button graphic, for example, and may render a composite image. As such, a graphical reward creator may, for example, enable a quest author to create a quest reward by supplying a suitable image. An artist or designer may offer an appealing custom graphic badge, avatar, or the like to participating users for “showing off” or displaying on their respective profile pages, quest-related pages, virtual community pages, or the like. Since a quest may be created or generated by a wider variety of authors or editors, for example, greater scalability of content may be achieved. In some instances, a quality of content, however, may vary or be affected in some manner. To address this, any suitable quest rating system or approach may be implemented or otherwise considered. For example, users may rate quests in terms of difficulty, story sophistication, rewards, fun, perceived location safety, or the like. If a certain editor creates or generates a lower quality quest, quest reward, etc., for example, such a quest may be ranked somewhat lower in a listing of quests presented to a user (e.g., upon log in, etc.). However, this is merely an example of a quest rating approach, and claimed subject matter is not limited in scope in this respect.

Accordingly, in an implementation, an ability of a user or editor to participate in or create a quest, interact with an on-line property, or the like may be an advantage provided by described client-server-type operating environment 100. For example, an API provided by a suitable server, such as server 102, may be used, at least in part, to support a GUI, network browser applications, etc. residing on or associated with one or more client devices. As such, a relatively seamless or coherent integration (e.g., visual, functional, etc.) may be possible between one or more varying client-type resident programs, different on-line properties, processes or operations (e.g., quest creation, reward presentation, user authentication, user action verification, etc.) or the like. For example, a browser-deployed application may facilitate or support user interaction with one or more on-line properties in connection with a quest relatively independently of hardware or software capabilities that may be available on client devices. Thus, a relatively small software load may be advantageously experienced by a thinner client device, such as a mobile phone, notepad, or PDA, for example, while one or more servers may carry a fuller load of multiple processes, operations, applications, services, or stored information, such as in the form of digital signals. Accordingly, by shifting, at least in part, certain computing burdens to one or more servers, users may experience coherent or cohesive content presentation, easier navigation or quest management, as well as other advantages of client-server-type operating or computing environment 100 including centralized storage, backup, enhanced security (e.g., user authentication, user action verification, etc.), or the like. Of course, claimed subject matter is not limited in scope to employing this particular approach. Rather, computing environment 100 is merely provided as one possible example of features as illustrated in example implementations described herein. Accordingly, many other approaches to providing similar or like features are available, and claimed subject matter is not limited in scope to any particular approach.

As previously mentioned, in certain implementations, server 102 or client device 110 may function, for example, as peer devices and may engage in peer-to-peer communications that may be supported by or otherwise associated with computing environment 100. Typically, although not necessarily, a peer-to-peer communication may refer to a type of a communication in which peers or like communication nodes of partially or substantially commensurate roles or capabilities may exchange information, such as in the form of stored digital signals, for example, or services with each other. For this example, peer devices 102 or 104 may serve, at times, as both server and client devices and may perform similar actions or functions as in a client-server network discussed above, such as, for example, retrieve quest-related details, register a location, enable creating or uploading a quest, provide a GUI to display quest-related details, detect machine-confirmable user actions, provide feedback regarding progress on a quest, or the like. Thus, a peer, such as server 102, client device 104, or like device associated with a particular user may detect the presence of one or more other peers via one or more appropriate techniques, for example, and may facilitate or support one or more processes or operations associated with creating or using a quest. Accordingly, here, quest-related details may be distributed or communicated from peer to peer, such as via bypassing a centralized or otherwise designated server, thus, allowing for a relatively independent or flexible system. It should be noted that one or more peers may be capable of providing suitable privacy-related settings or like controls, such as with respect to location-sharing, for example, so as to maintain users' privacy, if desired. Of course, details relating to a system for creating or using quests via peer-to-peer communication are merely examples, and claimed subject matter is not so limited.

FIG. 2 is a flow diagram illustrating an implementation of an example process 200 that may be performed, in whole or in part, to facilitate or support a quest. It should be appreciated that even though one or more operations are illustrated or described concurrently or with respect to a certain sequence, other sequences or concurrent operations may also be employed. In addition, although the description below references particular aspects or features illustrated in certain other figures, one or more operations may be performed with other aspects or features.

Example process 200 may begin at operation 202, for example, with a user registering or creating an electronic user profile in connection with a particular service provider, on-line property provider, or the like. A user may register or create a profile via any suitable process, such as a client-server process discussed above, for example, by providing identifying information, such as, user name, address, contacts, alias, and so forth, and may be prompted for a user ID or password selection. It should be appreciated that any forms or mechanics of registering or creating an electronic user profile may be utilized (e.g., via a web site, e-mail, telephone, fax, etc.). In some instances, such as for a previously registered or otherwise established user, for example, example process 200 may begin with logging onto a client-server system to begin participation in a quest. It should also be noted that in certain implementations a user may not necessarily be registered with, logged onto, etc. a client-server system, for example, to participate in a quest.

At operation 204, a user may visit or access a particular quest-related web site or page, for example, to read or otherwise obtain quest-related details. As previously mentioned, a web site or page may comprise a quest-related web site or page, for example, and quest-related details may comprise a list of available or applicable quests, quest histories, rewards, or the like. A user may, for example, visit or access a personal quest-related web page, a web site or page associated with a service provider, on-line property, or the like, as was also indicated. A web site or page may be supported by any suitable browser technology for on-line access or off-line communications of a user with a suitable server, such as, for example, server 102 of FIG. 1, as previously mentioned.

At operation 206, example process 200 may facilitate or support communication with a suitable server to get or obtain one or more digital signals representing quest-related details that may be applicable to a particular user. If a quest or quest-related details are found, as indicated generally at operation 208, example process 200 may proceed to operation 210 and may, for example, display relevant details to a user in a quest application window associated with a client device, as indicated generally at 210. On the other hand, example process 200 may proceed to operation 216, for example, to be terminated in some manner, such as without performing a quest.

As previously mentioned, during a quest, a user may, for example, interact with a suitable server (e.g., server 102 of FIG. 1, etc.) via a client device, wherein a server or client device may keep track of a user progress. In one implementation, to keep track of a user progress, a so-called “manual user submission or ‘check-in’ approach” may, for example, be implemented or otherwise considered, in whole or in part. For example, if a user performs a particular action, such as loads a URL, arrives or registers at a physical location, provides an answer (e.g., via typing or selecting on a display, touch screen, etc.), etc., the user may click on an on-screen “check-in” button so as to submit task-related communication to a suitable server. This, for example, may facilitate or support more efficient or effective tracking or processing of one or more applicable user actions, user progress, or the like. It should be appreciated, however, that claimed subject matter is not limited to a particular approach, and that any suitable approach or combination of approaches may be employed.

With regard to operation 212, it may be determined, for example, if a particular quest, such as a web-type quest, mixed reality quest, series of quests, etc. are executed or completed by a user. Example process 200 may also return to operation 202, for example, to repeat one or more functions associated with operations 204-212. Otherwise, a process may execute or complete a quest and may be subsequently terminated, as referenced at operations 214 and 216, respectively.

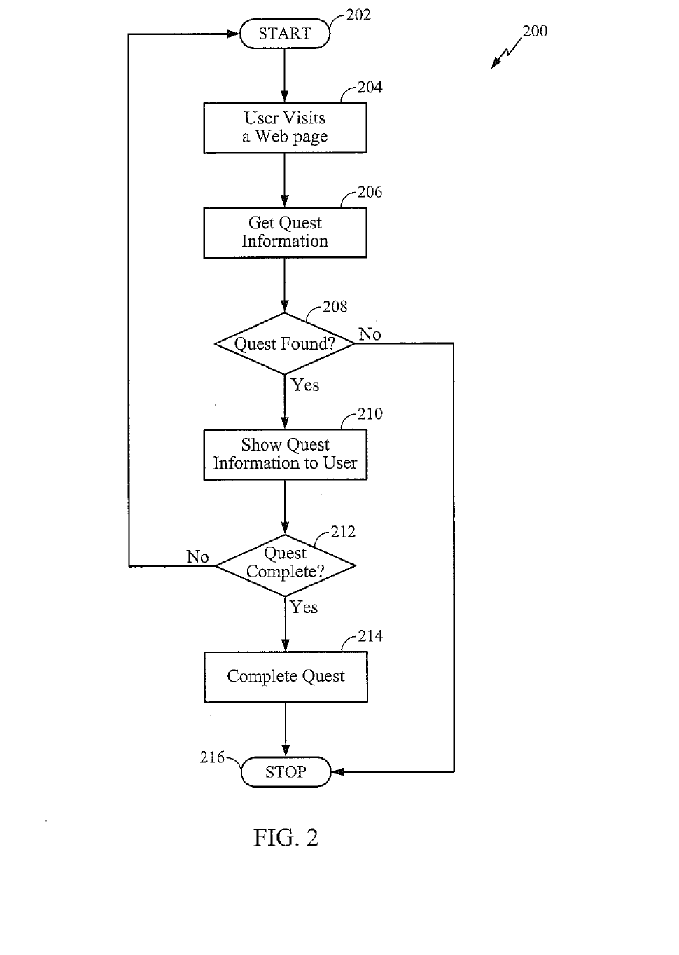

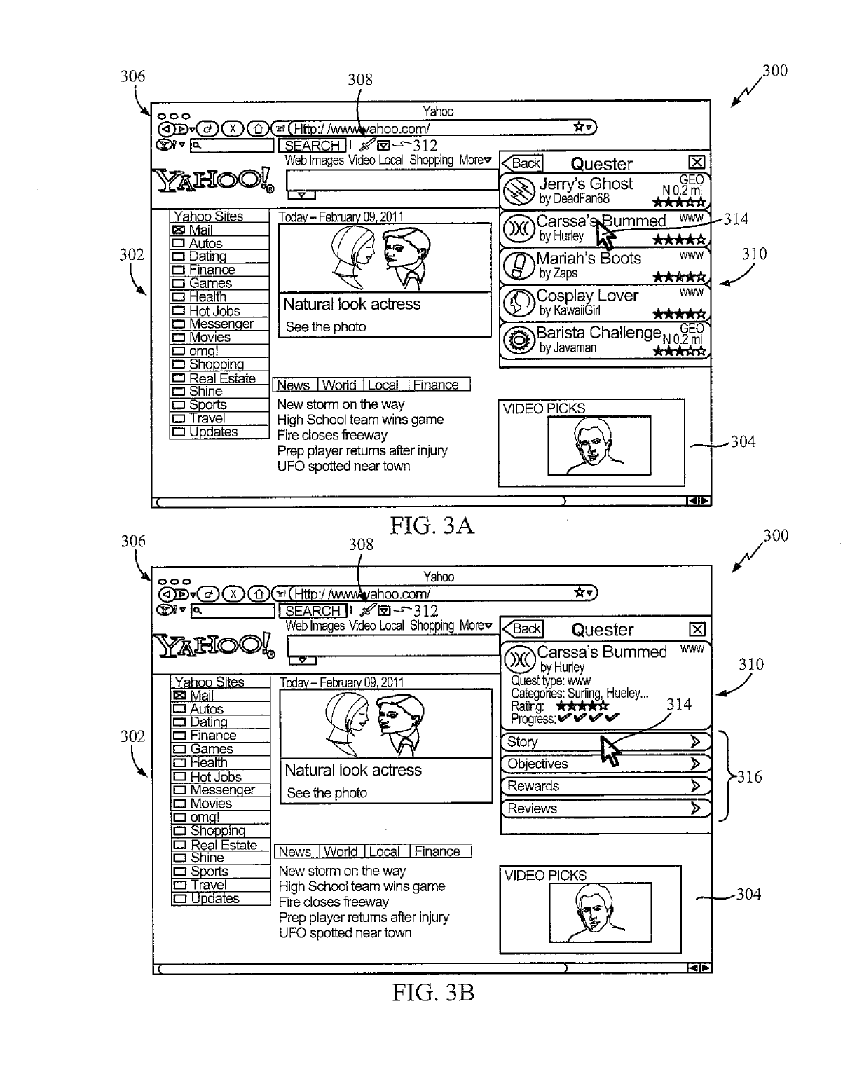

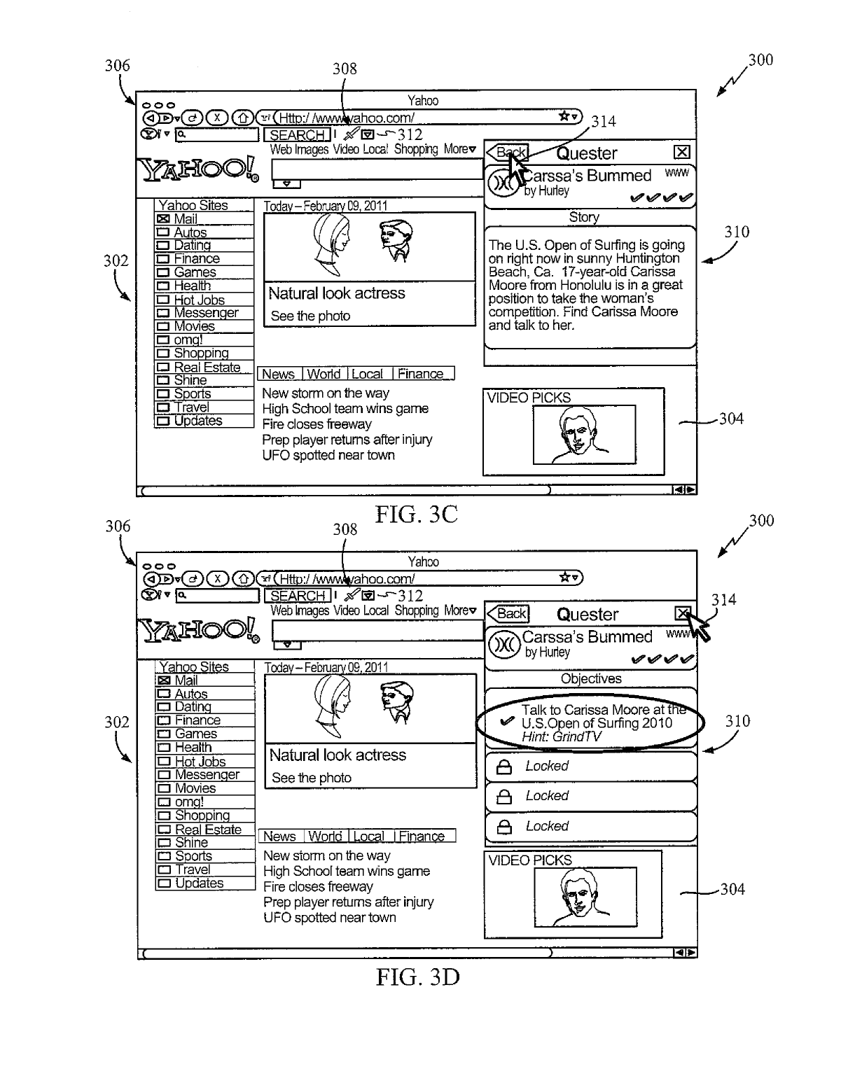

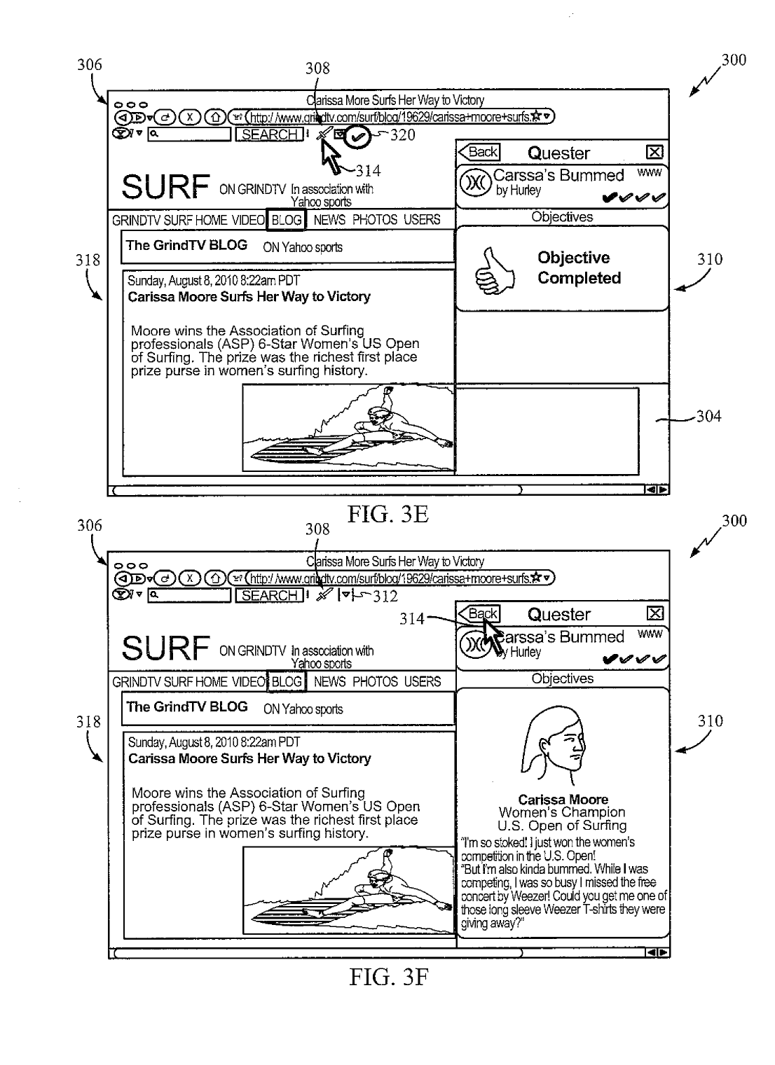

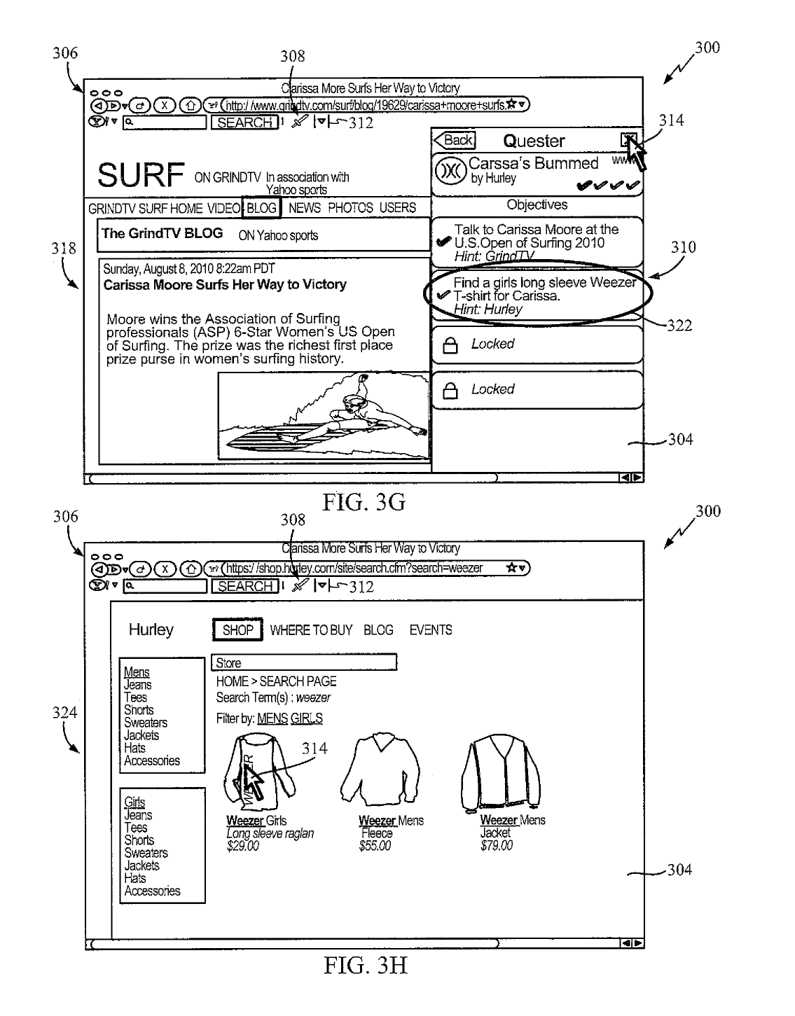

FIGS. 3A-3J are example representations of screenshot views of a display 300 that may be used, at least in part, to facilitate or support one or more processes or operations associated with a quest, such as process 200 of FIG. 2, for example, where a quest comprises a web-type quest. These figures may illustrate an example progression of a user participating in a quest, though claimed subject matter is not limited to such an example progression, of course. In addition, to simplify discussion, features or aspects of display 300 shown in FIG. 3A that correspond to like features or aspects illustrated in FIGS. 3B-3J may be given corresponding reference numbers, where applicable.

As illustrated in FIG. 3A, a user may access a suitable web site or page, referenced generally at 302, that may be associated with a service or on-line property provider, such as Yahoo!® (e.g., www.yahoo.com), for example, to view content of interest, participate in a quest, or the like. As previously mentioned, display 300 may comprise, for example, an on-line property-related application window 304 as a GUI for a computing application or platform to manage or manipulate content. It should be appreciated that even though visual content is illustrated in display 300, any suitable content including audio content, for example, or any combination thereof may be utilized. For this example, display 300 or an associated GUI may be operated or otherwise supported by a suitable client device, such as, for example, a desktop computer, a notebook, a laptop computer, or other special purpose computing device that may communicate with a suitable server via an electronic network (e.g., LAN, WAN, the Internet, etc). Display 300 may comprise, for example, a window toolbar 306 that may include a quest indicator 308, realized herein as a questing sword, to display log-in status regarding a signaling or communication connection to a suitable server, such as server 102 of FIG. 1.

Displayed in a foreground of or overlaid over visual content may, for example, be a quest application window 310, such as resulting from a selection of a quest-related menu button 312 on window toolbar 306 next to quest indicator 308. It should be appreciated that quest application window 310 or quest-related details may vary in size, location, or other attributes among visual content associated with on-line property-related application window 304 or display 300. It should also be noted that quest indicator 308, menu button 312, etc. may be positioned anywhere in on-line property-related application window 304 or display 300. In some instances, quest application window 310 may, for example, be generated or provided using, at least in part, a special purpose computer platform associated with a suitable server, such as server 102 of FIG. 1. For example, a client device hosting a GUI used to display quest application window 310 may communicate with a server on a network to bring up quest-related details stored with reference to a user ID in a suitable database (e.g., database 114 of FIG. 1, etc.), as previously mentioned. In some instances, quest application window 310 may, for example, be populated with quest-related details in a dynamic fashion, such as via a client-server communication without participation of a service or on-line property provider (e.g., Yahoo!®, etc.), as was also indicated. Of course, details with respect to a quest application window or a client-server relation are merely examples, and claimed subject matter is not so limited. For example, in certain implementations, a suitable application or like software may be hosted on a client device and may generate or provide quest application window 310 or quest-related details.

As seen, quest application window 310 may comprise, for example, a listing of available or applicable quests and may prompt a user for a quest selection. As a way of illustration, a user may choose or select any suitable quest, such as, for example, the quest “Carissa's Bummed” created by an advertising sponsor (e.g., Hurley International of Mesa, Calif., etc.). A quest selection may be carried out via a pointer 314, for example, in connection with a suitable pointing device. As used herein, a pointer may, for example, refer to a cursor, arrow, or other suitable icon or symbol that may appear on display 300 and may be moved or otherwise controlled with a pointing device to select quests, populate fields, input commands, or the like via a GUI of a client device. A pointing device may refer to any device used to control a cursor, arrow, etc., to select quests, populate fields, input commands, or the like. As a way of illustration, a pointing device may include, for example, a mouse, a trackball, a track pad, a track stick, a keyboard, a stylus, a digitizing tablet, or the like. As used herein, terms “click” or “clicking” may refer to a selection process made by any pointer or pointing device, though use of these terms is not intended to be so limited. For example, a selection process may be made via a touch screen, wherein “clicking” may be replaced by “touching.” However, these are merely examples of methods of selecting quests, inputting commands, etc., and claimed subject matter is not limited in scope in these respects.

As further seen in FIG. 3B, quest application window 310 may comprise one or more fields, user-selectable or otherwise, resulting from a selection of a particular quest (e.g., “Carissa's Bummed,” etc.), for example. Quest application window 310 may display certain quest-related details or statistics, such as, for example, a quest name or title, quest type (e.g., WWW or a web-type, etc.), category, rating, status regarding a quest progress, or the like. Here, a user may access or view applicable or suitable quest-related details such as, for example, a quest-related story, one or more associated tasks or objectives, offered rewards, may post or read peer reviews, or the like by clicking on one or more selectable tabs, indicated generally at 316.

As particularly seen in FIG. 3C, quest application window 310 may display or present a quest-related story, which may be a result of a user selection of a corresponding tab (e.g., “story,” etc.), as referenced via pointer 314 in FIG. 3B. As previously mentioned, a quest-related story may comprise any suitable instruction including, for example, a navigation or travel-related instruction, task or objective-related instruction, story-related instruction, question or trivia-related instruction, adventure-related instruction, or other instruction that may associate a user with particular content. To illustrate, in an implementation, a story may describe some event, current or otherwise, such as the U.S. Open of Surfing 2010, for example, and may instruct a user to “talk” to Carissa Moore, the surfer “in a great position to take the women's competition,” though claimed subject matter is not so limited, of course. If a user continues with a quest, such as via clicking or otherwise selecting a “Back” button by pointer 314, for example, one or more quest-related tasks or objectives may appear in quest application window 310, as shown in FIG. 3D. As seen, a task or objective may relate to a story and may instruct a user to “talk” to Carissa Moore at the U.S. Open of Surfing 2010, as one possible example. As also illustrated, here, one or more tasks or objectives may be “locked” or presented in a “grayed-out” fashion so as to let a user know that they cannot currently be attained or selected, for example. As mentioned above, displaying “locked” tasks or objectives may encourage continued user participation, provide an incentive or motivation to further pursue tasks or objectives leading to more rewards, or otherwise provoke user curiosity. In some instances, quest application window 310 may provide a location-related hint, for example, that may be used, at least in part, to direct or entice a user to a particular location, help to associate a user with particular content, or the like. For example, a hint may instruct a user, directly or indirectly, to travel or navigate to an on-line location, such as a particular web page (e.g., GrindTV, etc.) in order to execute or complete a task or objective. A user may travel or navigate to a location by clicking on or following a hyperlink, for example, specifying the location, if provided, or, optionally or alternatively, by performing an on-line search via any suitable search engine (e.g., Yahoo!® Search, accessible at http://search.yahoo.com, etc.) or like information management system. For this example, a user may search for “GrindTV,” just to illustrate one possible approach.

As previously mentioned and as illustrated in FIG. 3E, by traveling or navigating to a particular on-line location, such as to a web page 318, for example, a user may perform a machine-confirmable action, such as an action that may be confirmed via electronically uploading of an associated URL (e.g., http://www.grindtv.com, etc.). To facilitate or support this, a suitable server, such as a back-end server associated with a client-server network, for example, may perform one or more operations with respect to a submitted URL, which may include a URL sub-string matching operation, just to illustrate one possible implementation. For example, a server may check whether all or parts of a particular URL specified by a quest author or editor includes or corresponds to all or parts of a URL submitted by a user. This may allow a quest author or editor to specify a shortened version of a URL for more effective or efficient URL string matching, for example, which may filter or otherwise ignore certain non-descriptive or fragmentary parameters that may be appended onto an end of or included with a submitted URL. As a result, quest application window 310 indicating that a task or objective has been executed or completed may, for example, appear in a foreground of visual content. As was indicated, content may comprise, for example, a blog, article, picture, virtual item, physical merchandise, etc. and may be associated with a suitable service provider, on-line property provider, advertising sponsor, or the like. As seen, for this example, content may comprise an article regarding Carissa Moore's winning the U.S. Open of Surfing 2010, for example, located at a particular web site or page associated with an on-line property, such as Yahoo!® Sports, for example. Claimed subject matter is not so limited, of course. Also shown, in some implementations, a suitable icon or like task or objective-related indicator, such as a checkmark icon 320, for example, may appear on toolbar 306 or any other suitable place in display 300 as a result of executing or completing a task or objective.

Turning now to FIG. 3F, as a result of a user action, such as via clicking on quest indicator 308 on window toolbar 306 of FIG. 3E by pointer 314, for example, a personalized task or objective may appear in quest application window 310 that may prompt or otherwise encourage a user to continue with a quest. For example, a task or objective may comprise a personal appeal or request by “bummed” Carissa Moore to assist her in finding a “long-sleeve Weezer t-shirt” the group was giving away while she was competing, as illustrated. If a user selects an option to continue with a quest, such as via clicking by pointer 314 on an appropriate button (e.g., a “Back” button, etc.), for example, next “unlocked” or otherwise applicable task or objective may appear in quest application window 310, as circled generally at 322 in FIG. 3G. As seen, here, quest application window 310 may inform a user (e.g., via a hint, etc.) that particular content, such as “a girls long-sleeve Weezer t-shirt,” for example, may be found at a certain location (e.g., Hurley store, etc.) to which a user may navigate to execute or complete a task or objective. As previously mentioned, this task or objective may appear as a result of a user's “unlocking” a previous or lower-level task or objective, such as “talking” to Carissa Moore, for example.

FIG. 3H is a representation of a screenshot view of display 300 illustrating an example web site 324 associated with a particular quest author or editor, such as an advertising sponsor (e.g., Hurley International, etc.), as one possible example. As was indicated, a web site may comprise or be representative of a quest-related location, for example, to which a user may navigate to execute or complete a quest-related task or objective. It should be appreciated that quest application window 310 may or may not remain displayed in a foreground of visual content or any portion of display 300, for example, while a user is searching for or navigating to a location. In some instances, having traveled or navigated to a location (e.g., https://shop.hurley.com, etc.), a user may be asked, directly or indirectly, or otherwise may be instructed to browse through visual content so as to find a particular task or objective-related content, such as, for example, an item qualifying a user for a reward (e.g., a “Weezer” t-shirt, etc.). Here, by asking or instructing a user to browse through content, an advertising sponsor may, for example, be able to showcase additional or similar items or merchandise, introduce promotional offers, or the like as part of a marketing campaign, as previously mentioned. For this example, having browsed through content, if applicable, a user may, for example, find or select a task or objective-related t-shirt by clicking on an appropriate image (e.g., via pointer 314 in FIG. 3H, etc.) so as to execute or complete a task or objective, as further illustrated in FIG. 3I. As discussed above, upon or after execution or completion, task or objective-related information, such as in the form of digital signals may, for example, be communicated by a client device via an electronic network to a suitable server so as to confirm a detected user action. As seen in FIG. 3J, having confirmed a user action, a server may communicate an applicable reward 326, in real time or otherwise, to be displayed in some manner in display 300 associated with a client device, such as, for example, in quest application window 310. As illustrated, a reward may comprise, for example, an electronic coupon redeemable at a participating sponsor (e.g., Hurley International, etc.), just to illustrate one possible implementation. Accordingly, as described herein, a quest may associate a user of a client device with content in an effective of efficient manner. Of course, details relating to a web-type quest in general or display 300 in particular are merely examples, and claimed subject matter is not limited in these regards.

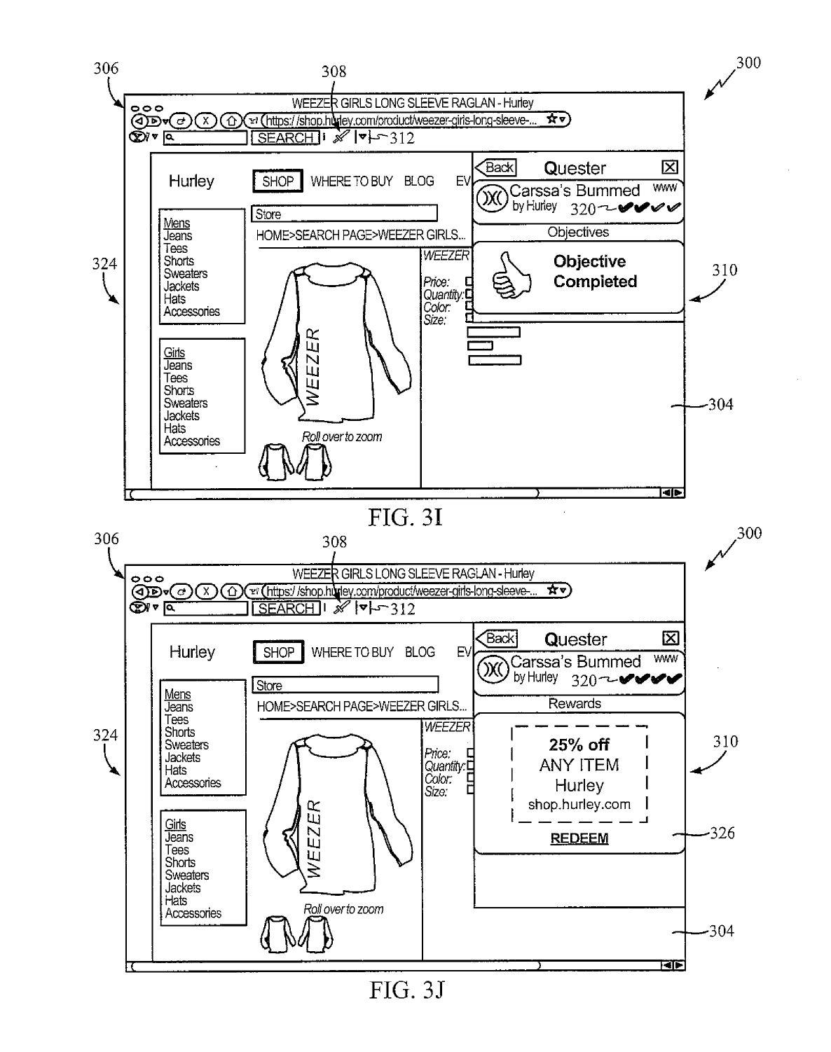

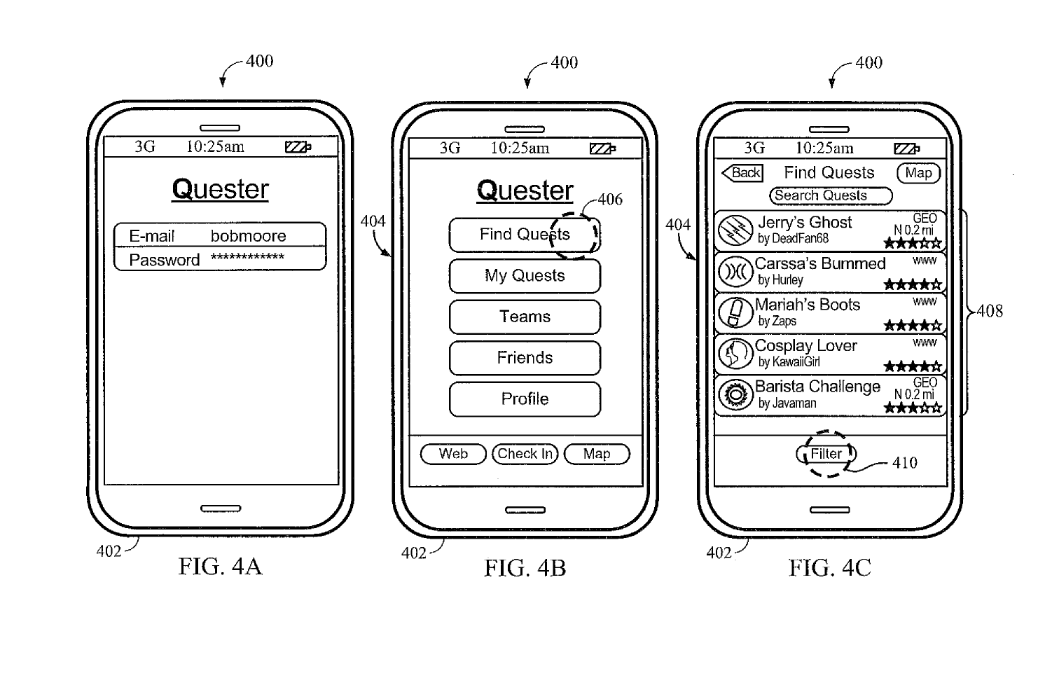

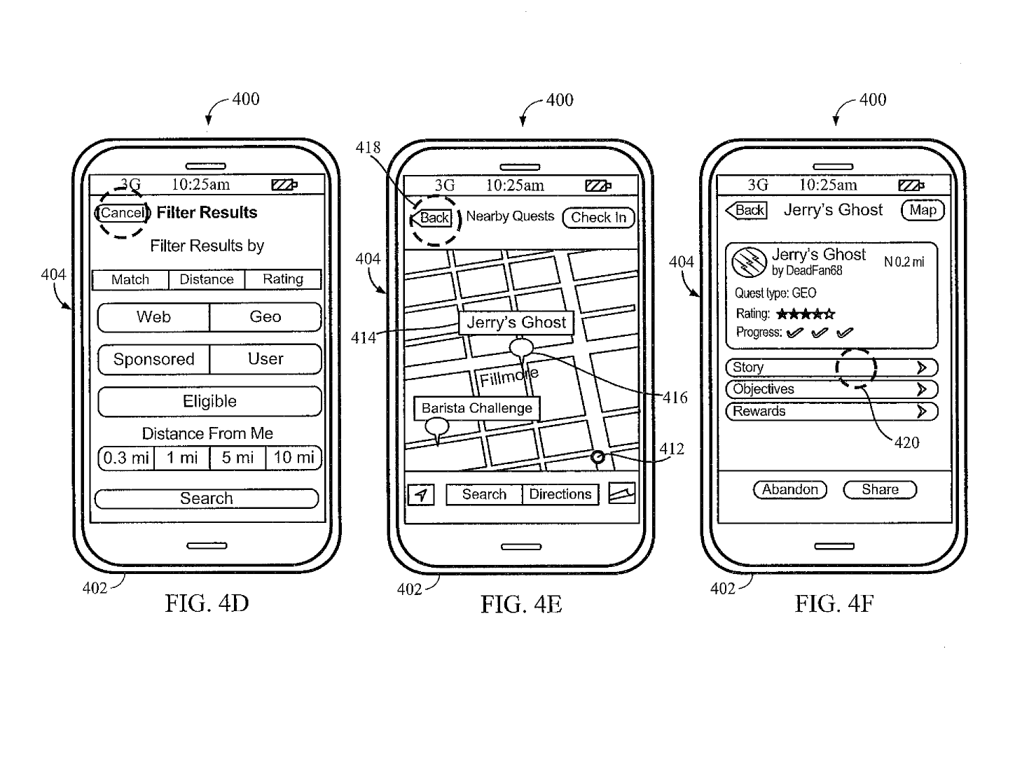

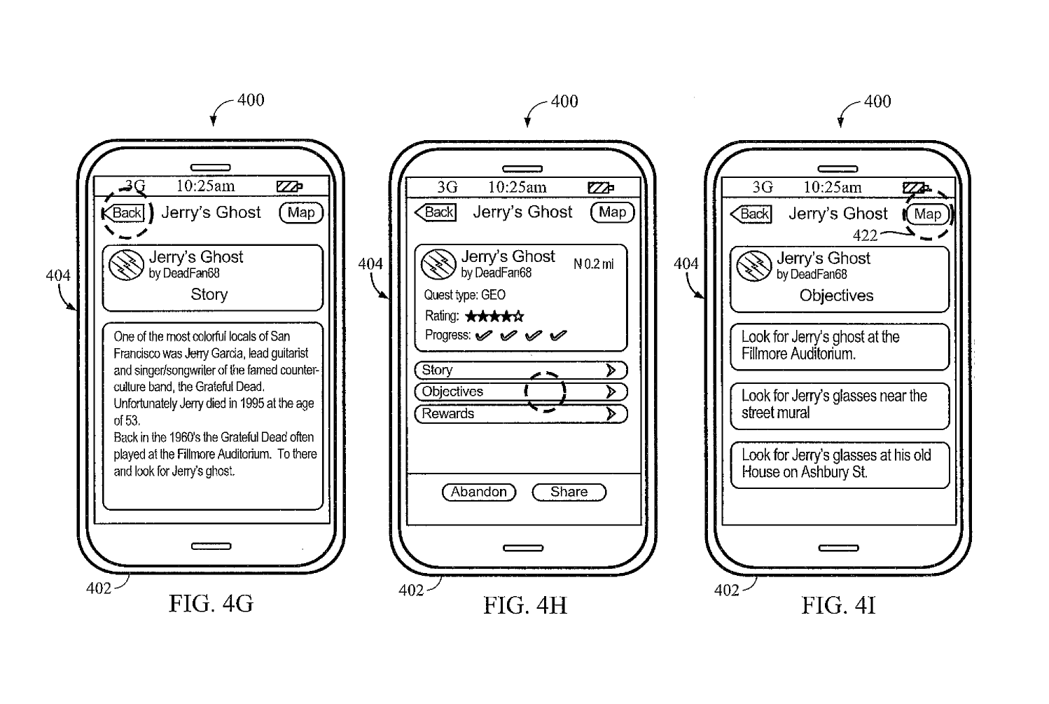

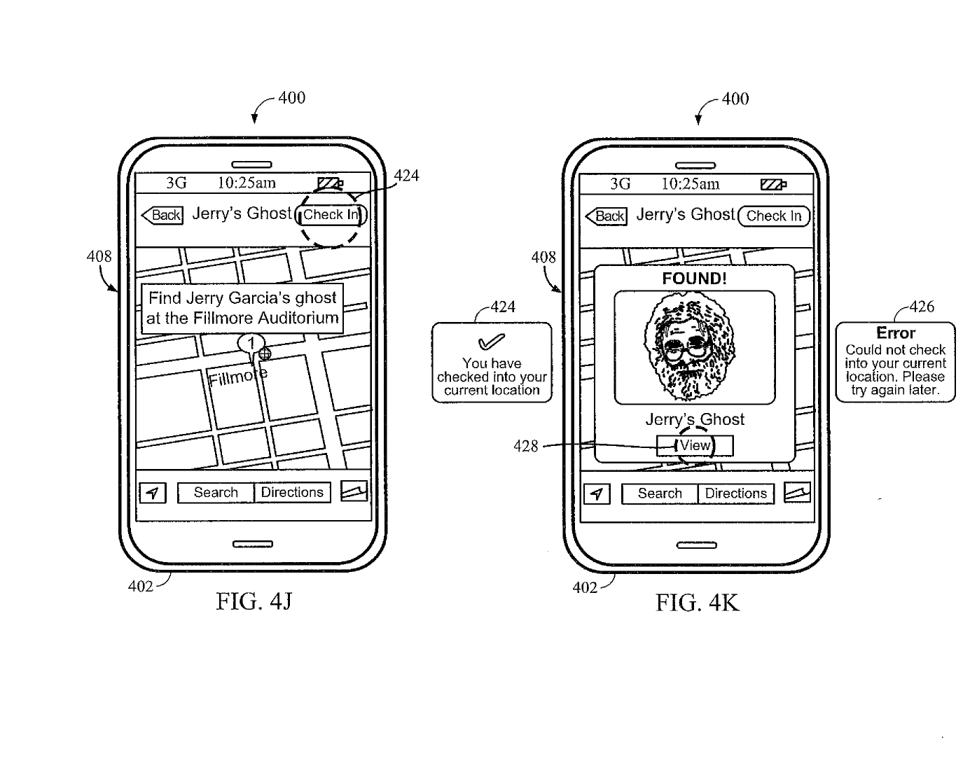

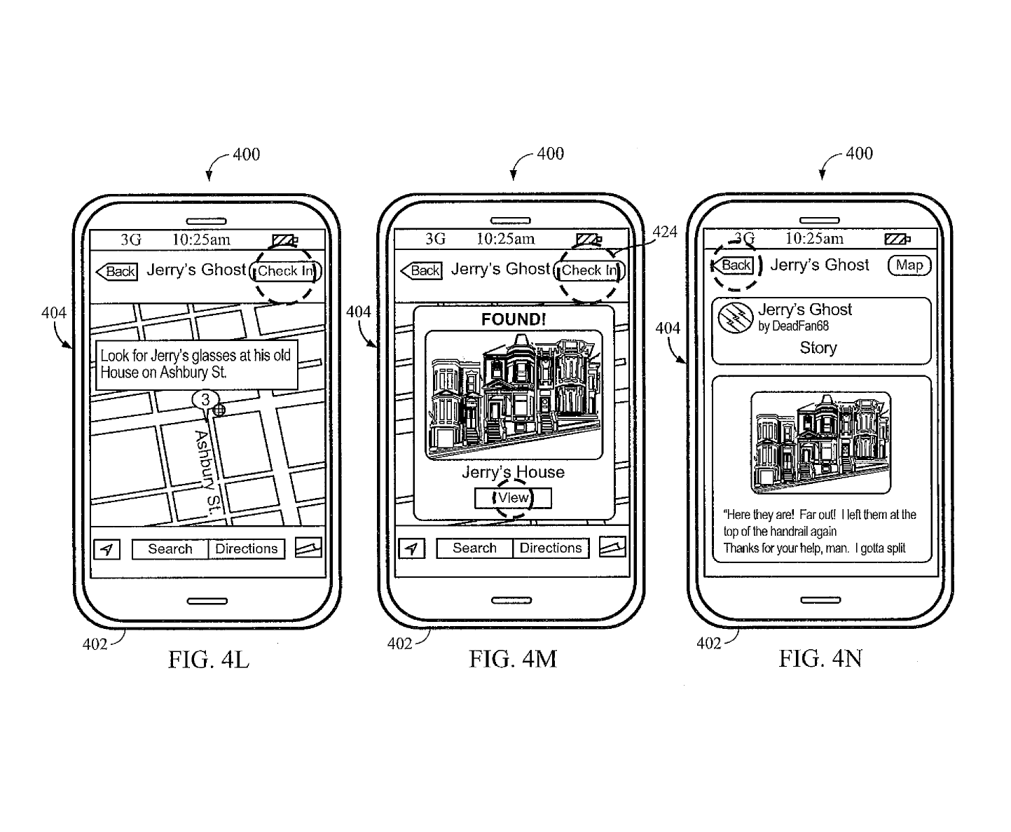

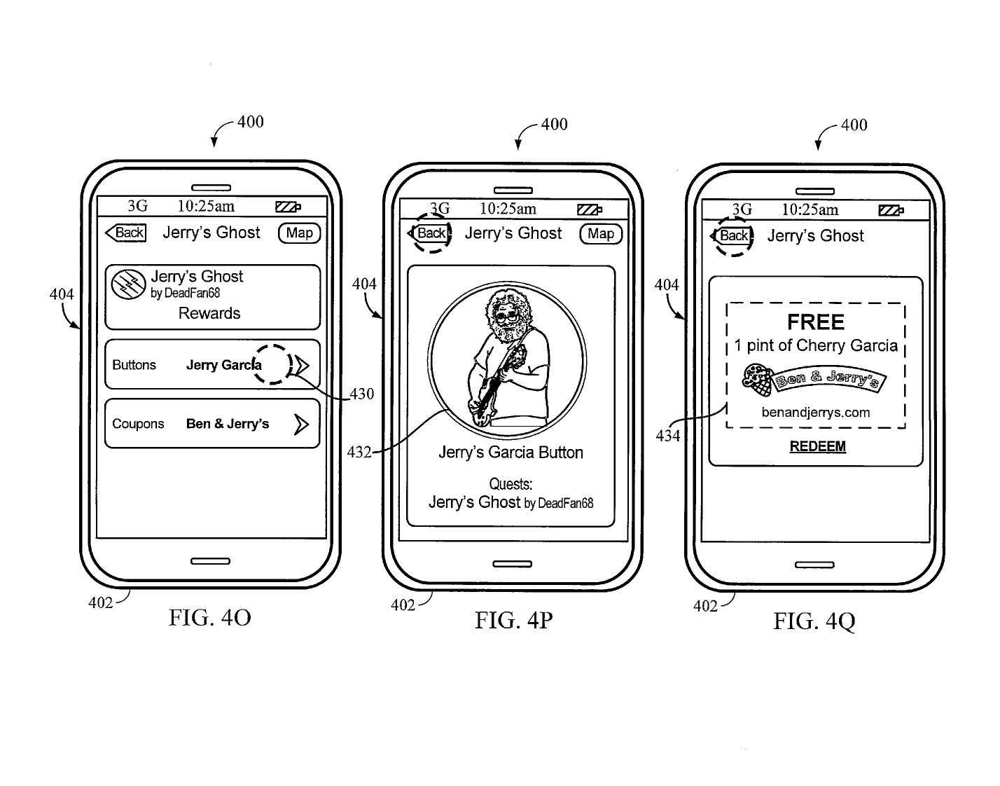

FIGS. 4A-4Q are example representations of screenshot views of a display 400 that may be used, at least in part, to facilitate or support one or more processes or operations associated with a quest, such as process 200 of FIG. 2, for example, where a quest comprises a mixed reality quest. Again, these figures may illustrate an example progression of a user participating in a quest, though claimed subject matter is not limited to such an example progression, of course. In addition, to simplify discussion, features or aspects of display 400 shown in FIG. 4A that correspond to like features or aspects illustrated in FIGS. 4B-4Q may be given corresponding reference numbers, where applicable.

As previously mentioned, a mixed reality quest may be performed, at least in part, in a fashion similar to a web-type quest, such as, for example, in a fashion discussed above. As was also indicated, with respect to a mixed reality quest, a task or objective-related location may comprise, for example, a physical or real world location, such as detectable via a geo-location feature of a mobile device, an on-line location detectable via an uploading of a URL, or any combination thereof. As illustrated in FIG. 4A, a mixed reality quest may, for example, be performed in connection with a suitable application such as, for example, the “Quester” mobile application that may reside on a client device, though claimed subject matter is not so limited. For example, in some instances, a mixed reality quest may be performed in connection with a network browser residing on a client device that receives quest-related details from a network server, as discussed above. Display 400 or an associated GUI may be operated or otherwise supported by a suitable mobile device 402, such as, for example, a smart telephone, cellular telephone, notepad, PDA, etc. that may communicate with a suitable server via an electronic network, such as LAN, WAN, the Internet, or the like. It should be appreciated that even though mobile device 402 is realized herein as an example smart telephone, any suitable device may be utilized herein.

As seen, mobile device 402 may, for example, prompt a user for an ID (e.g., bobmoore, etc.), password, or like user-identifying information so as to launch an application, access a quest, or the like. In an implementation, based, at least in part, on user ID and password, such as at or after logging onto a suitable client-server network, for example, mobile device 402 may prompt a user to find one or more available or applicable quests, such as via a quest application window 404, as seen in FIG. 4B. As mentioned above, in some instances, quest application window 404 may comprise, at least in part, display 400, though claimed subject matter is not so limited. For example, quest application window 404 may vary, such as in size, location, or other attributes of display 400, which may depend, in whole or in part, on an application. A user may find one or more available or applicable quests by clicking, for example, on a corresponding on-screen button or bar, as referenced generally via a dashed circle at 406, or like user-selectable GUI element. As also shown, a user may view certain quests (e.g., partially or substantially executed or completed, saved, etc.), invite one or more users to join a quest team, communicate with friends, view a user profile, or the like by clicking on corresponding on-screen bars. Particular examples of organizing a quest team, features of a user profile, or the like will be illustrated below. Subsequent to a selection of a corresponding button or bar, such as bar 406, for example, a user may be presented with a listing of available or applicable quests 408 in quest application window 404, as seen in FIG. 4C. As was indicated, listing of available or applicable quests 408 may be downloaded from a suitable server on a client-server network in connection or with reference to a particular user ID, perhaps in real time.

In an implementation, a mobile application may feature a capability to filter one or more quests, such as, for example, by a physical location, distance to a user, eligibility, type, rating, or the like. Thus, if a user wishes to filter one or more quests, for example, a user may click on a corresponding on-screen button or bar, as referenced via a dashed circle at 410. As a result, one or more user-selectable filter options may, for example, appear in quest application window 404, as depicted in FIG. 4D. In some instances, a user may choose or select an option to view one or more nearby quests in a digital map displayed in quest application window 404, for example, in relation to a user (e.g., via a pin or indicator 412, etc.), as further illustrated in FIG. 4E. A digital map may be provided, for example, by a suitable web mapping service application that may reside on mobile device 402 or may be rendered by a network browser capable of communicating with a suitable server or service (e.g., map-based, etc.). Here, a user may select a quest by clicking on or touching a portion of visual content, such as a graphical box or like element designating a quest, for example, on quest application window 404. For example, a user may choose to participate in the “Jerry's Ghost” quest by clicking on a graphical box 414, just to illustrate one possible implementation. Optionally or alternatively, a user may select a quest of interest by clicking on or touching a corresponding map-related symbol or icon, such as, for example, a portable network graphic (PNG) digital pin or balloon 416 indicative of a quest location. Claimed subject matter is not so limited, of course.

Having found a quest of interest, such as the “Jerry's Ghost,” for example, a user may operate mobile device 402 to display or bring up one or more quest-related details or statistics in quest application window 404. For example, to accomplish this, a user may select or click on graphical box 414, balloon 416, a “Back” button 418, etc. shown in FIG. 4E, though claimed subject matter is not so limited. As previously mentioned and as seen in FIG. 4F, quest-related details or statistics may comprise, for example, a quest name or title, quest author or creator (e.g., DeadFan68, etc.), branding field or logo, quest type (e.g., GEO or a mixed reality, etc.), rating, progress, or the like. In some instances, quest application window 404 may display, for example, a geographic distance to a selected quest in relation to a user (e.g., North 0.2 miles, etc.) provided via a geo-location or tracking feature of mobile device 402. As also shown, a user may abandon or share a quest by selecting, for example, respective on-screen options in quest application window 404, if desired. As illustrated generally via an example progression in FIGS. 4F-4I, similarly to a web-type quest discussed above, here, a user may select or view a quest-related story (via a button 420, etc.), one or more associated tasks or objectives, offered rewards, etc. by clicking on one or more corresponding user-selectable tabs, referenced generally via respective dashed circles. At times, a user may view a task or objective-related progress, such as a user's current location on a digital map displayed in quest application window 404, for example, by selecting a corresponding button or tab, such as a button 422, just to illustrate one possible implementation. Of course, claimed subject matter is not limited to a particular quest-related story, tasks or objectives, rewards, graphical elements, or example progression shown.

Continuing now with FIG. 4J, a user may perform a machine-confirmable action by traveling or navigating to a particular task or objective-related location, which may comprise a physical or real world location, such as the Fillmore Auditorium where Jerry Garcia used to play, for example, and performing a “check in,” as previously mentioned. As illustrated, a user may view or track a current location of mobile device 402 in a suitable manner, such as, for example, in relation to a task or objective-related location on a digital map displayed in quest application window 404. As was indicated, in a mixed reality quest, a “check in” may be performed, at least in part, by registering or reporting GPS coordinates, for example, via a location-tracking feature of mobile device 402 (e.g., via push or pull technology, etc.) while at a task or objective-related location. For example, to perform a machine-confirmable action, a user may select an appropriate on-screen button or like element, such as a button 424, for example, while in the Fillmore Auditorium, though claimed subject matter is not so limited. As a result, an indication or confirmation that a task or objective has been executed or completed may appear in quest application window 404, as illustrated in FIG. 4K.

As also seen in FIG. 4K, a task or objective-related indication or confirmation may be personalized or customized in some manner, such as, for example, via displaying an image of the “Jerry's Ghost” (e.g., created by a quest editor, etc.) in quest application window 404 along with a caption “Found!” In some instances, a comment confirming a successful or otherwise sufficient “check in,” such as a comment 424, for example, may appear anywhere in quest application window 404, such as in a foreground of visual content. If a “check in” is unsuccessful or insufficient, however, such as if a user has not reached a specified quest-related location, for example, or a geo-location feature of mobile device 402 is disabled, or one or more GPS-related signals are not available, or the like, an error message may be provided or communicated to a user. For example, in some instances, a “check in” related error message may comprise an example indicated at 426, which may appear in quest application window 404 in response to a user's attempt to check into a current location, as discussed above, though claimed subject matter is not so limited. In such a case, mobile device 402 may provide an opportunity to perform a “check in” at a later time, for example, via one or more user-selectable on-screen options.

As further illustrated in FIGS. 4L-4N, a mixed reality quest may comprise one or more other quest-related tasks or objectives, such as looking for Jerry's glasses at his old house on Ashbury Street, for example, or the like that may be viewed (e.g., via a button 428 of FIG. 4K, etc.), executed or completed in a similar fashion. Upon execution or completion of one or more quest-related tasks or objectives, a suitable server (e.g., server 102 of FIG. 1, etc.) may communicate one or more applicable rewards to mobile device 402, in real time or otherwise, to be displayed in quest application window 404, as shown in FIG. 40. Here, a user may select a reward by clicking, for example, on a corresponding button or bar, as indicated generally via a dashed circle at 430, and may view the reward in quest application window 404. As illustrated in FIG. 4P, a reward may comprise, for example, a virtual button 432 having a custom image of Jerry Garcia created by a quest author or editor (e.g., DeadFan68, etc.). Virtual button 432 may comprise a thumbnail image, which may be converted to a larger-size or smaller-size rendition via any suitable application hosted on mobile device 402, if desired, so as to be conveniently displayed in a user profile page, personal web page, or the like. As previously mentioned, in some instances, a reward may comprise, for example, an electronic coupon redeemable at a participating sponsor, such as a coupon for Cherry Garcia ice cream redeemable at Ben & Jerry's, shown generally at 434 in FIG. 4Q as another possible example. Accordingly, as described herein, a quest may associate a user of a client device with content. Again, details relating to a mixed reality quest in general or display 400 in particular are merely examples, and claimed subject matter is not limited in these regards.

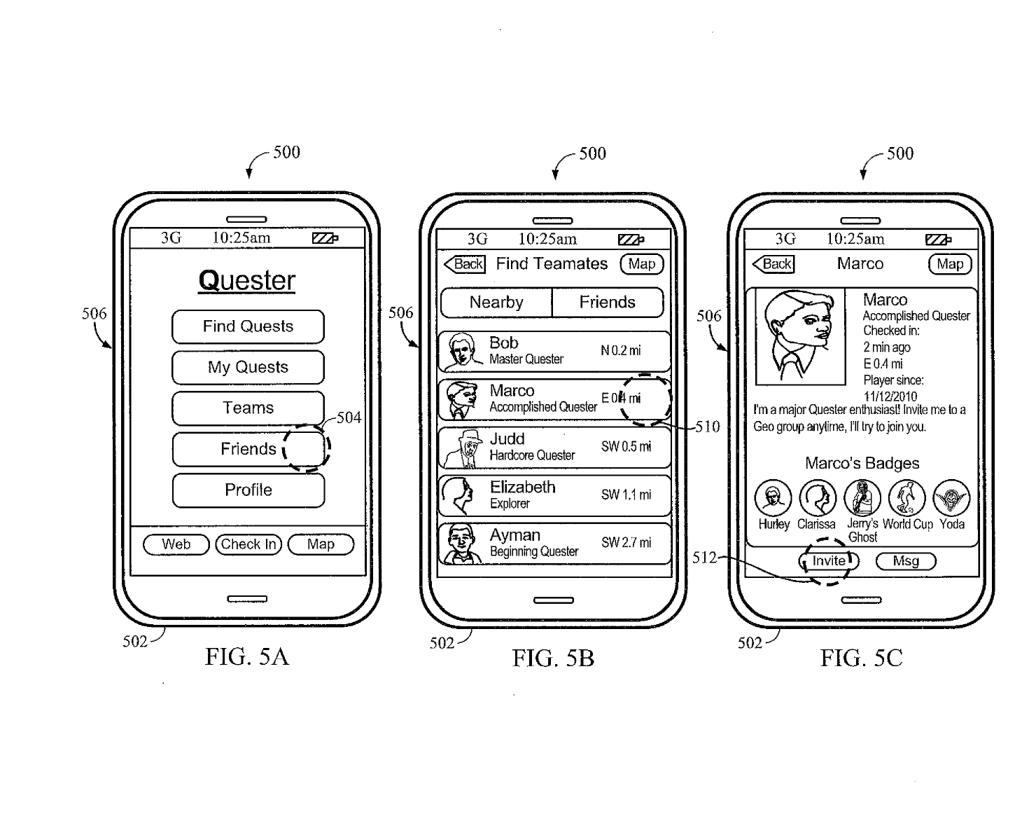

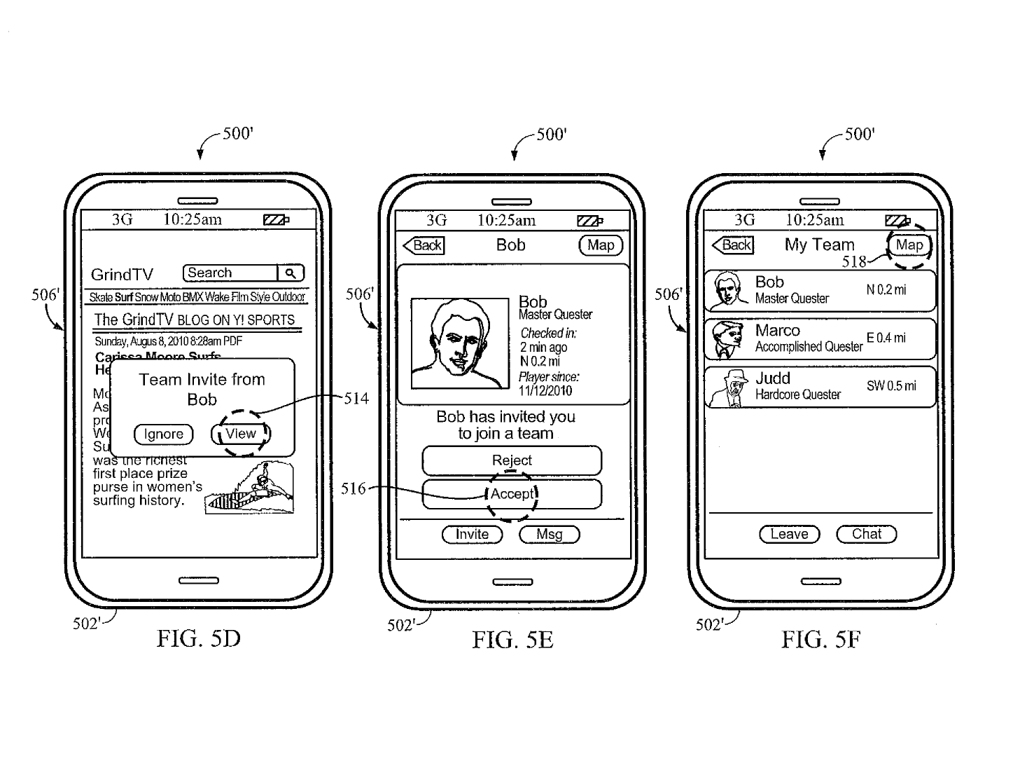

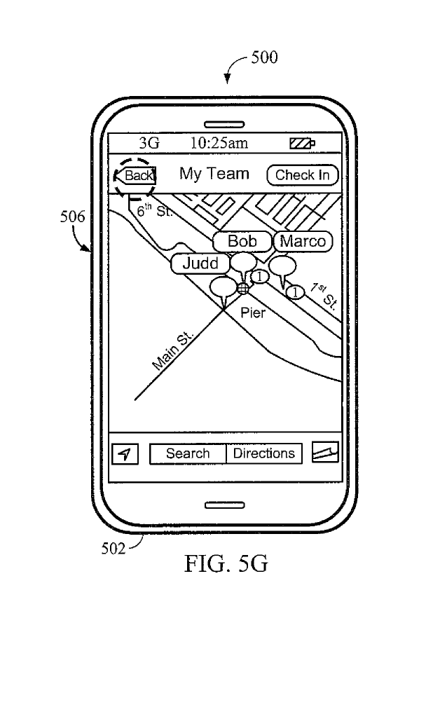

FIGS. 5A-5G are example representations of screenshot views of a display 500 that may be used, at least in part, to facilitate or support one or more processes or operations associated with a quest, such as, for example, in connection with a team quest. Again, these figures may illustrate a certain example progression, though claimed subject matter is not so limited. In addition, to simplify discussion, features or aspects of display 400 shown in FIG. 5A that correspond to like features or aspects illustrated in FIGS. 5B-5G may be given corresponding reference numbers, where applicable.

As illustrated in FIG. 5A, a user associated with a mobile device 502 may find quest teammates, such as one or more friends who are currently logged onto a client-server network, for example, via display 500 by clicking on or selecting a corresponding on-screen option, such as a bar or button 504. As previously mentioned, display 500 may comprise, in whole or in part, a quest application window 506 with an associated GUI to facilitate or support suitable client-server interactions. As a result of clicking on bar 504, a server may, for example, communicate with mobile device 502, perhaps in real time, such as with respect to one or more logged in users, user IDs, names, geographic locations, or the like, as depicted in FIG. 5B. As was indicated, in some instances, prior to logging onto a quest-related client-server network, one or more users may, for example, share respective locations, activate a tracking feature, etc. so as to mitigate privacy issues. Upon or after selecting a particular user (e.g., Marco, etc.), such as via a bar or button 510, for example, quest application window 506 may display a user profile of a selected user, as further illustrated in FIG. 5C. As seen, a user profile may include, for example, an image or avatar of a user, user title, current location, playing experience or time joined, rewards earned, a personal message, or the like. Claimed subject matter is not limited to particular implementation shown, of course. A user may send an invitation to join a quest team via any suitable communication approach, such as via a text or short messaging service (SMS) message, e-mail, phone call, or the like by clicking on or selecting a bar or button 512, for example.

FIG. 5D illustrates an example message that an invited friend or user may receive or view on a display 500′, for example, or associated quest application window 506′ of a client device 502′. To simplify discussion, with respect to an invited friend or user, features of display 500′ of client device 502′ that correspond to features of display 500 of mobile device 502 are given the same reference number with the addition of a prime (′). By way of example but not limitation, an invited friend or user (e.g., Marco, etc.) may view a received invitation, such as from Bob (e.g., a team organizer, creator, member, etc.), for example, by clicking on a bar or button 514. As a result, a personal information regarding an inviting user (e.g., Bob, etc.) as well as one or more user-selectable options may appear in quest application window 506′, as seen in FIG. 5E. For example, quest application window 506′ may include one or more on-screen selectable options allowing an invited friend or user to reject or accept an invitation to participate in a team quest, to invite other users to join, if desired, to view a quest or teammates on a digital map, to compose a response message, or the like. If an invited friend or user chooses to participate in a team quest, such as by accepting an invitation via a bar or button 516, for example, client device 502′ may communicate via a suitable server, such as to bring up or otherwise display in quest application window 506′ a listing of current teammates, as shown in FIG. 5F. As discussed above and as also shown, a team member may leave or drop out of a quest, communicate with one or more teammates via a team chat channel, etc., such as by clicking on or otherwise selecting a corresponding on-screen option in quest application window 506′, for example.

As seen in FIG. 5G, a member of a quest team may, for example, view one or more quest-related tasks or objectives (e.g., content, etc.), geographic locations of current teammates, may track or interact with other members of a quest team, or the like, such as via a digital map provided on display 500, just to illustrate one possible implementation. This may facilitate or support convenient collaboration among quest teammates, for example, and may allow multiple users to participate in a quest, divide certain quest-related tasks or objectives, such as to share a credit or reward, or the like, as previously mentioned. As such, in a possible implementation, a mixed reality quest in general or a team quest in particular may provide benefits of a more streamlined, more user-friendly social interaction in a variety of environments, such as in a virtual world, physical or real world, or any combination thereof. Upon or after execution or completion of one or more quest-related tasks or objectives, for example, a team quest may be disbanded or dissolved, as was also indicated. Of course, a description of a team quest or its benefits is merely an example, and claimed subject matter is not so limited.

FIGS. 6A and 6B are example representations of screenshot views of a display 600 that may be used, at least in part, to facilitate or support one or more processes or operations associated with creating a quest via an authoring tool. It should be appreciated that even though a description of an authoring tool comprises visual content, any type of content including, for example, audio content or any combination thereof may be utilized. It should also be noted that a description of a particular quest, such as the “Carissa's Bummed” quest discussed above, one or more quest-related tasks or objectives, locations, rewards, or the like are provided herein as merely examples to which claimed subject matter is not limited.

In an implementation, to begin a process of creating a quest, a quest author or editor may, for example, access any suitable web site or page 602 that may be associated with an authoring tool (e.g., Yahoo!® Developer Network, etc.). An authoring tool may comprise any suitable software application that may be provided by an on-line property or service provider, such as Yahoo!®, for example, allowing an editor with or without development skills (e.g., non-programmer, etc.) to create a suitable quest. Web site 602 may be supported by any suitable browser technology for on-line access or off-line communications of a client device with a suitable server, such as, for example, server 102 of FIG. 1. In some instances, web site 602 may be accessed from a quest-related web site, for example, or, optionally or alternatively, via a mobile application hosted on a client device. For example, images on display 600 or its associated GUI may be executed or generated by a special purpose client device, such as client device 110 of FIG. 1, which may communicate with a server via an electronic network, such as a LAN, a WAN, the Internet, or the like. Display 600 may comprise, for example, an application window 604 as a GUI for a computing application or platform to manage or manipulate visual or other content, such as entering a quest-related story, one or more tasks or objectives, locations, rewards, or the like, as described below.

As illustrated in FIG. 6A, window 604 may include one or more fields that an editor may use to enter quest-related details or instructions. For example, an editor may enter a quest name or title, author, or category via respective input fields, referenced generally at 606. An editor may also choose whether quest-related tasks or objectives may be executed or completed in order, whether to hide locked tasks or objectives, etc., such as by clicking on respective fields 608 and 610, for example, and checking a corresponding box using a mouse or other pointing device. An editor may add a suitable number of tasks or objectives, task or objective-related hints, or the like, if desired, via a drop-down menu 612, for example. In addition, an editor may, for example, specify one or more task or objective-related locations (e.g., for “check ins,” etc.) by inputting a destination URL, GPS coordinates, etc., may compose a personalized task or objective-related message, or the like and may view results via selecting respective menu buttons, referenced generally at 614. As also shown, an editor may create or add one or more rewards via a number of selectable on-screen options, indicated generally at 616. As previously mentioned, a reward may comprise, for example, a virtual button, illustrated at 618, displayable on a profile page, personal web site or page, or the like.

As seen, window 604 may include one or more images 620, which may comprise, for example, Joint Photographic Experts Group (JPEG) or other type of formatted files. As was indicated, an editor may use one or more images to convey or enhance a quest-related story, communicate a task or objective, indicate a location, or the like. If desired, an editor may edit or otherwise modify one or more quest-related details or instructions using one or more corresponding buttons, referenced generally at 622. As also shown, window 604 may, for example, provide options to save, preview, or publish or upload a quest upon or after its execution or completion, such as via buttons 624, 626, or 628, respectively. In some instances, a created quest may be uploaded into any suitable repository, such as database 114 of FIG. 1, for example, that may be associated with a server on a network, such as server 102 of FIG. 1, just to illustrate one possible implementation.

As further illustrated in FIG. 6B, an authoring tool may facilitate or support viewing quest-related details or instructions, such as, for example, a story-related text, image, task or objective, hint, location or destination URL, or the like via one or more populated fields, referenced generally at 630. As previously mentioned, an editor may edit or modify quest-related details, such as via button 622, for example, if desired. Thus, an authoring tool may provide an effective, convenient, or simple-to-use quest authoring or editing experience via a user interface via which a quest author or editor may, for example, enter text for a story, one or more tasks or objectives, locations, rewards, related images, or the like, just to illustrate one possible implementation. In some instances, text may be inputted, for example, in the form of a text string, URL, or the like, as also illustrated. Accordingly, an authoring tool may allow for sufficient flexibility in terms of how various quest-related parts or components (e.g., a story, location, task or objective, reward, etc.) may be combined or integrated. For example, as illustrated, a quest author or editor may reveal tasks or objectives progressively or all at once, specify tasks or objectives to be executed or completed in a given order or allow them to be executed or completed in any order, mix different task or objective types in the same quest, have more than one task or objective to be executed or completed contemporaneously (e.g., enter text while at a particular URL, geo-location, etc.), or the like. Of course, a description of creating a quest in connection with an authoring tool or its benefits is merely an example, and claimed subject matter is not limited in this regard.

Accordingly, as discussed herein, a system for creating or using one or more quests may provide benefits. For example, a quest may associate one or more users with content, non-game-related or otherwise, and, as such, may present a number of revenue-generating opportunities. As previously mentioned, a web-type quest may, at times, increase on-line traffic to a web site or page associated with an on-line property or service provider (e.g., Yahoo!®, etc.), for example, which in turn may increase a number of page views for on-line property advertisers. A web-type quest may, for example, provide an additional motivation for a user to visit or explore on-line content, which may help to introduce additional or existing ads. Accordingly, in some instances, an on-line property or service provider may, for example, utilize a web-type quest, in whole or in part, as an additional form of on-line advertising.

In addition, a sponsored web-type quest may comprise, for example, an approach or vehicle for directing a user to one or more web sites or pages associated with an advertising sponsor, such as for a entertainment rather than or instead of a “hard sell.” A digital reward may comprise or add to a rich user experience, for example, by having a creative or artistic dimension, such as via high-quality animated avatars or accessories, graphic buttons or badges, or the like. These rewards may provide entertainment as well as relatively low-cost incentives for drawing users to web sites or pages of interest (e.g., sponsor-related, on-line property provider-related web sites, etc.). Furthermore, hiding one or more within-page quest-related tasks or objectives, rewards, or other items, such as behind spoof ads, for example, may motivate users to inspect display ads or even click, such as in trying to assess if they contain a “treasure.”

A mixed-reality quest may, for example, help to increase foot traffic to physical stores or locations associated with an advertising sponsor, company, provider, or the like. For example, one or more users may travel or navigate to physical locations so as to execute or complete a quest, and in the process of doing so may discover additional stores, promotions, merchandise, or the like. Here, quest rewards may take the form of a redeemable coupon or certificate, for example, potentially encouraging users to spend money, such as while in-store. Also, a mixed-reality or web-type quest may, for example, comprise a relatively inexpensive or scalable tool that may help to create engaging experiences around a particular brand, on-line or in physical locations.

In some instances, a quest may advantageously add one or more social dimensions. For example, users may interact by participating in a single-user quest in parallel, such as by exploring, executing or completing tasks or objectives, earning rewards, etc., such as together while physically co-present. Users may also participate in a team quest and may advantageously share a credit for executing or completing one or more tasks or objectives, as previously mentioned. Users may also share one or more quests, credits, rewards, etc. asynchronously, for example, such as by challenging another to participate in a particular quest over a suitable social networking web site (e.g., Facebook®, etc.). In addition, users may be capable of “showing off” personalized rewards (e.g., on profile pages, personal web pages, etc.), for example, which may be representative or descriptive of traits, characters, attitudes, etc. to other users. User-generated quests may also comprise a kind of a social interaction, for example, in which users may share an experience with a quest author or editor by participating in a quest. Of course, a description of certain social aspects of a quest or its benefits is merely an example, and claimed subject matter is not so limited.

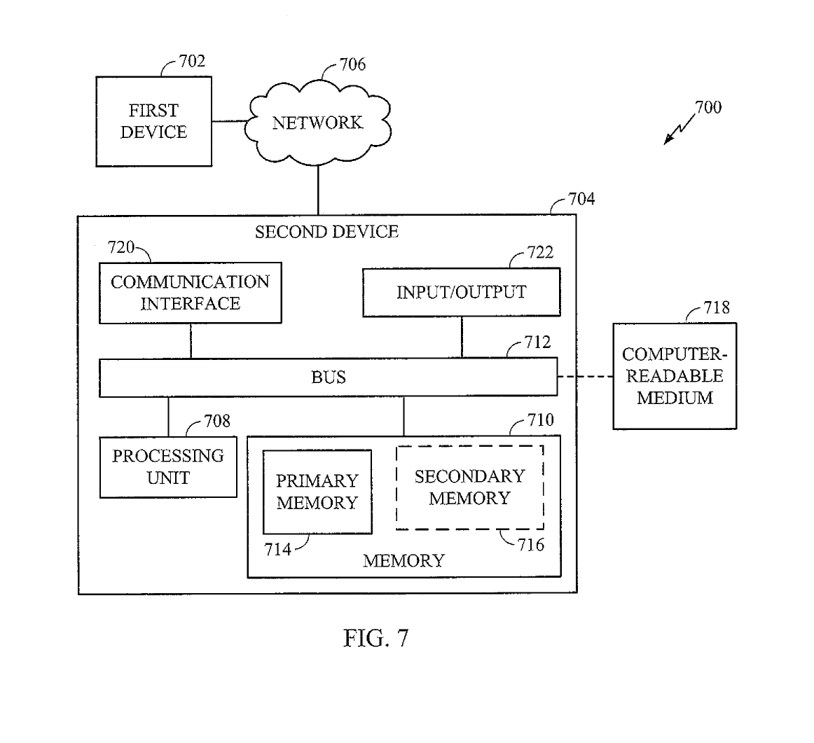

FIG. 7 is a schematic diagram illustrating an example computing environment 700 that may include one or more devices that may be capable of implementing, in whole or in part, one or more processes or operations for a quest. Computing environment system 700 may include, for example, a first device 702 and a second device 704, which may be operatively coupled together via a network 706. In an embodiment, first device 702 and second device 704 may be representative of any electronic device, appliance, or machine that may have capability to exchange signal information over network 706. Network 706 may represent one or more communication links, processes, or resources having capability to support exchange or communication of signal information between first device 702 and second device 704. Second device 704 may include at least one processing unit 708 that may be operatively coupled to a memory 710 through a bus 712. Processing unit 708 may represent one or more circuits to perform at least a portion of one or more signal information computing procedures or processes.

Memory 710 may represent any signal storage mechanism or appliance. For example, memory 710 may include a primary memory 714 and a secondary memory 716. Primary memory 714 may include, for example, a random access memory, read only memory, etc. In certain implementations, secondary memory 716 may be operatively receptive of, or otherwise have capability to be coupled to, a computer-readable medium 718.

Computer-readable medium 718 may include, for example, any medium that may store or provide access to signal information, such as, for example, code or instructions for one or more devices in operating environment 700. It should be understood that a storage medium may typically, although not necessarily, be non-transitory or may comprise a non-transitory device. In this context, a non-transitory storage medium may include, for example, a device that is physical or tangible, meaning that the device has a concrete physical form, although the device may change state. For example, one or more electrical binary digital signals representative of information, in whole or in part, in the form of zeros may change a state to represent information, in whole or in part, as binary digital electrical signals in the form of ones, to illustrate one possible implementation. As such, “non-transitory” may refer, for example, to any medium or device remaining tangible despite this change in state.

Second device 704 may include, for example, a communication adapter or interface 720 that may provide for or otherwise support communicative coupling of second device 704 to a network 706. Second device 704 may include, for example, an input/output device 722. Input/output device 722 may represent one or more devices or features that may be able to accept or otherwise input human or machine instructions, or one or more devices or features that may be able to deliver or otherwise output human or machine instructions.

According to an implementation, one or more portions of an apparatus, such as second device 704, for example, may store one or more binary digital electronic signals representative of information expressed as a particular state of a device such as, for example, second device 704. For example, an electrical binary digital signal representative of information may be “stored” in a portion of memory 710 by affecting or changing a state of particular memory locations, for example, to represent information as binary digital electronic signals in the form of ones or zeros. As such, in a particular implementation of an apparatus, such a change of state of a portion of a memory within a device, such a state of particular memory locations, for example, to store a binary digital electronic signal representative of information constitutes a transformation of a physical thing, for example, memory device 710, to a different state or thing.

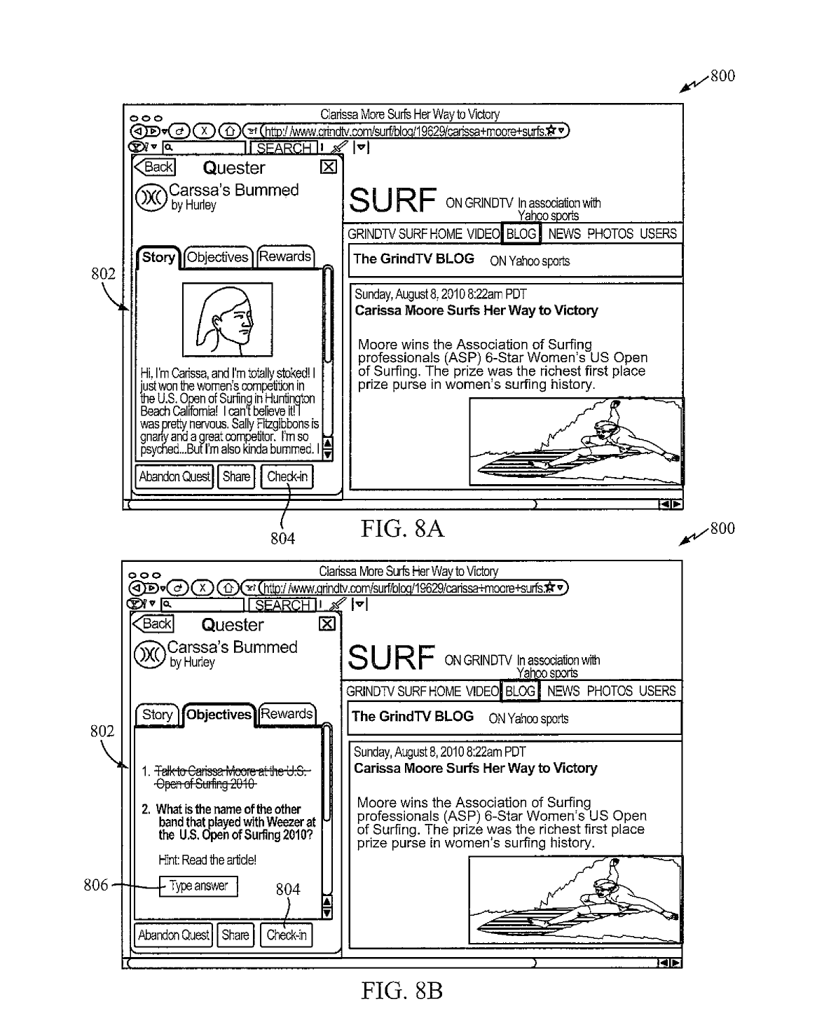

FIGS. 8A and 8B are example representations of screenshot views of a display 800 that may be used, at least in part, to facilitate or support one or more processes or operations associated with a quest, such as process 200 of FIG. 2, for example, where a quest is implemented in connection with a quest application window realized as a sidebar 802. Likewise, here, display 800 or an associated GUI may be operated or otherwise supported by a suitable client device, such as, for example, a desktop computer, a notebook, a laptop computer, mobile telephone, smart telephone, or other special purpose computing device that may communicate with a suitable server via an electronic network (e.g., LAN, WAN, the Internet, etc). As seen in FIG. 8A, in some implementations, participating in a quest may involve little or no toolbar interaction, as discussed above, from a user since sidebar 802 may stay open, such as in display 800, for example, while or until a quest is executed or completed (e.g., most of the time, all the time, etc.). Similarly, sidebar 802 may comprise, for example, one or more fields, user-selectable or otherwise, that may provide any suitable quest-related details. For example, as illustrated in FIG. 8B, sidebar 802 may include one or more quest-related tasks or objectives comprising a question a user may answer to obtain a reward, such as in connection with a question or trivia-related quest, just to illustrate one possible implementation. For this example, a user may perform a machine-confirmable action, for example, by submitting a typed answer (e.g., correct, corresponding, etc.), a URL, a geo-location, etc. to a suitable server via a “check in” button 804. As a way of illustration, sidebar 802 may, for example, comprise an input-line textbox 806, which may allow a user to type a quest-related answer, as one possible option. Of course, details relating to a display, web browser, or quest application window are merely examples to which claimed subject matter is not limited. For example, even though Mozilla Firefox® browser is illustrated in FIGS. 8A-8B, any suitable browser, such as Windows Internet Explorer®, Google Chrome®, Safari®, or the like may also be employed.

Thus, as illustrated in various example implementations or techniques presented herein, in accordance with certain aspects, a method may be provided for use as part of a special purpose computing device or other like machine that accesses digital signals from memory or processes digital signals to establish transformed digital signals which may be stored in memory as part of one or more information files or a database specifying or otherwise associated with an index.

Some portions of the detailed description herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels.

Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Terms, “and” and “or” as used herein, may include a variety of meanings that also is expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe some combination of features, structures or characteristics. Though, it should be noted that this is merely an illustrative example and claimed subject matter is not limited to this example.

While certain example techniques have been described or shown herein using various methods or systems, it should be understood by those skilled in the art that various other modifications may be made, or equivalents may be substituted, without departing from claimed subject matter. Additionally, many modifications may be made to adapt a particular situation to the teachings of claimed subject matter without departing from the central concept(s) described herein. Therefore, it is intended that claimed subject matter not be limited to particular examples disclosed, but that claimed subject matter may also include all implementations falling within the scope of the appended claims, or equivalents thereof.

What is claimed is:

1. A method comprising:
electronically generating one or more task-type instructions as part of performing a quest; and
detecting one or more machine-confirmable user actions indicating execution of said one or more task-type instructions.

2. The method of claim 1, wherein said one or more machine-confirmable user actions qualify one or more users for a reward.

3. The method of claim 2, wherein said reward comprises at least one of the following: a physical reward; a virtual reward; or any combination thereof.

4. The method of claim 2, wherein said reward comprises at least one of the following: a reward visible in a quest application window prior to said execution of said one or more task-type instructions; an indication of a reward visible in a quest application window prior to said execution of said one or more task-type instructions; a reward not visible in said quest application window prior to said execution of said one or more task-type instructions; or any combination thereof.

5. The method of claim 1, wherein said one or more task-type instructions are generated by at least one of the following: a provider of an on-line property; an advertising sponsor; one or more users; or any combination thereof.

6. The method of claim 1, wherein said one or more task-type instructions are generated in connection with an authoring tool.

7. The method of claim 6, wherein said authoring tool is provided by a provider of an on-line property.

8. The method of claim 1, wherein said one or more machine-confirmable user actions comprises one or more user actions confirmable via an application of a server-side process.

9. The method of claim 1, wherein said one or more task-type instructions direct one or more users to at least one of the following: a web page specified via a uniform resource locator (URL); a physical location specified via global positioning system (GPS) coordinates; or any combination thereof.

10. The method of claim 1, wherein said one or more task-type instructions associate one or more users with non-game-related content.

11. The method of claim 1, wherein said one or more task-type instructions comprises one or more adventure-related instructions.

12. The method of claim 11, wherein said one or more adventure-related instructions comprises one or more story-related navigation instructions.

13. A method comprising:
generating one or more visual indicators to be displayed with displayable content,
said one or more visual indicators being based, at least in part, on execution of one or more task-type instructions by one or more users as part of performing a quest.

14. The method of claim 13, wherein said one or more visual indicators are overlaid over at least a portion of at least one of the following: a web page specified via a URL; a digital map representative of a physical location specified via GPS coordinates; a display associated with a client device; or any combination thereof.

15. The method of claim 13, wherein said one or more visual indicators are at least partially hidden or obscured in at least one of the following: a web page specified via a URL; a quest application window; a digital map representative of a physical location specified via GPS coordinates; a display associated with a client device; or any combination thereof.

16. The method of claim 13, wherein said one or more visual indicators are overlaid without participation of at least one of the following: a provider of an on-line property; an advertising sponsor; said one or more users; or any combination thereof.

17. The method of claim 13, wherein said one or more users comprise a group of two or more mutually interacting users sharing one or more machine-confirmable user actions in response to said one or more task-type instructions.

18. An apparatus comprising:
a computing platform comprising at least one processor to:
generate one or more digital signals representative of a task-type instruction displayed in a quest application window associating one or more users with content;
electronically detect one or more machine-confirmable user actions in response to said task-type instruction; and
electronically keep track of said one or more machine-confirmable user actions in said quest application window upon or after said one or more users have been associated with said content.

19. The apparatus of claim 18, wherein to said electronically keep track of said one or more machine-confirmable user actions comprises to keep track of at least one of the following: an on-line location of said one or more users; a physical location of said one or more users; a user input detectable via said one or more machine-confirmable user actions; or any combination thereof.

20. The apparatus of claim 18, wherein said task-type instruction is generated by at least one of the following: a provider of an on-line property; an advertising sponsor; said one or more users; or any combination thereof.
